(19) United States
(12) Patent Application Publication
(10) Pub. No.: US 2007/0220580 A1
(43) Pub. Date: Sep. 20, 2007

(54) User interface for a media convergence platform

(76) Inventors: Daniel Putterman, San Francisco, CA (US); Brad Dietrich, San Francisco, CA (US); Pedro Freitas, San Francisco, CA (US); Jeremy Toeman, San Francisco, CA (US); John Doornbos, San Francisco, CA (US); Paul Novaes, San Mateo, CA (US); Keith Craigie, San Francisco, CA (US); Anne Swabb, Oakland, CA (US); David Williams, San Francisco, CA (US)

Correspondence Address: Stattler-Suh PC, 60 SOUTH MARKET, SUITE 480, SAN JOSE, CA, 95113, US

(21) Appl. No.: 10/099,064

(22) Filed: Mar. 14, 2002

(51) Int. Cl. H04N 7/173; G06F 13/00; G06F 15/00; G06F 3/00; G06F 17/00; H04N 5/445; H04N 7/16

(52) U.S. Cl. 725/134; 725/142; 715/500.1; 715/501.1; 725/61; 725/87

(57) ABSTRACT

A user interface for a media convergence platform is disclosed. The television based user interface presents different types of media within a single user interface. The user interface displays, on a television display, selectable items to represent a music application, a photo albums application, a video application, and an Internet content application. The user selects an item displayed on the television display to invoke an application. The music application permits a user to select music available within the media convergence platform, and to playback the music through a device in the media convergence platform. The photo albums application permits a user to select one or more photos available within the media convergence platform, and to view the photos through a device in the media convergence platform. The video application permits a user to select one or more videos or video clips available within the media convergence platform and to playback the video/video clips through a device in the media convergence platform. The Internet content application permits a user to select an Internet content provider, available to the media convergence platform, and to receive content from the Internet content provider for playback on a device. The user interface also includes an edit mode, for editing items within the applications, and a status mode for obtaining system level status.

### COPYRIGHT NOTICE

The drawings contain material that is subject to copyright protection. The copyright owner has no objection to the facsimile reproduction of the drawings as it appears in the United States Patent and Trademark patent files or records, but otherwise reserves all copyright rights whatsoever.

### BACKGROUND OF THE INVENTION

1. Field of the Invention

The present invention is directed toward the field of converging disparate types of media, and more particularly directed toward a user interface for a system that converges different types of media.

2. Art Background

The widespread use of computers, digital cameras, and the Internet has resulted in the creation and use of digital media. Digital media has also largely replaced more traditional analog audio and video formats with the introduction and popular acceptance of audio compact discs (CDs) and digital video discs (DVDs). In general, digital media consists of various formats of data that stores audio, video, and images in binary files. These binary files are typically stored on a medium accessible to computer devices, such as CD-ROMs, hard drives, floppy disks and memory sticks.

The storage of digital media on commonly used computer medium allows for easy generation and transfer of digital media. For example, it has become popular to generate digital photos using a digital camera and then to transfer the digital photos onto computers. Computer software permits the user to manipulate the digital photos. The user may then transfer the digital photos to friends using e-mail, or post the digital photos on a web site accessible by the World Wide Web. These types of applications, which take advantage of the connectivity among different devices, have also contributed to the widespread popularity of digital media.

Digital media may be stored in a variety of formats. Special hardware or software compatible with the formats of the digital media is required to playback or view the digital media. For example, to listen to music stored in the popular MP3 format, a consumer must have a special MP3 player (i.e., either software running on a general purpose computer or a stand alone MP3 player). There are numerous formats for video, including high quality DVDs and various compression based MPEG standards. To playback various formats of digital video, the consumer must use a device that reads the proper format of the digital media.

Because of the numerous different formats of digital media, the playback or viewing of numerous types of digital media today requires multiple types of devices. The playback of digital media stored in different formats is less problematic on a computer because the computer may playback the digital media using software programs. However, a consumer may desire to playback the media on other types of devices. For example, the consumer may desire to playback digital audio files on a home stereo and view digital video on a television. Currently, stereos and televisions are not equipped to playback various formats of digital media. Accordingly, it is desirable to provide a media convergence platform that integrates various types of digital media into a single system. It is also desirable to provide a user interface for the media convergence platform that permits a user to manage, browse and playback different types of media from a single integrated user interface.

### SUMMARY OF THE INVENTION

A user interface for a media convergence platform presents different types of media within a single user interface. The user interface is television based. The user interface displays, on a television display, selectable items to represent a music application, a photo albums application, and a video application. The use selects an item displayed on the television display to invoke an application. The music application permits a user to select music available within the media convergence platform, and to playback the music through a device in the media convergence platform. The photo albums application permits a user to select one or more photos available within the media convergence platform, and to view the photos through a device in the media convergence platform. The video application permits a user to select one or more videos or video clips available within the media convergence platform and to playback the video/video clips through a device in the media convergence platform.

The user interface also displays a selectable item on the television display to represent an Internet content application. The Internet content application permits a user to select an Internet content provider, available to the media convergence platform, and to receive content from the Internet content provider for playback on a device. The user interface also permits the user to edit information associated with the applications. In one embodiment, the edit mode is only invoked in response to predetermined user input (e.g., user presses an edit key on the remote control). This hides items, associated with the edit mode, from display until a user selects to enter the edit mode. Also, the user interface displays system wide status when requested by a user.

### BRIEF DESCRIPTION OF THE DRAWINGS

FIG. 1 illustrates a media space configured in accordance with one embodiment of the present invention.

FIG. 2 illustrates one embodiment for integrating devices into a single media space.

FIG. 3 illustrates an example screen of a top-level or introduction screen for the user interface.

FIG. 4 illustrates an example introductory screen for the music jukebox application.

FIG. 5 illustrates an example screen for the “Now Playing” function.

FIG. 6 illustrates an example screen displayed by the system if the user selects the menu button on the remote control in the context of the Now Playing function.

FIG. 7 illustrates an example screen displayed by the system in response to the user selecting the menu item “Save as New Playlist” from the edit menu of FIG. 6.

FIG. 8 illustrates an example screen for displaying playlists.

FIG. 9 is an example screen displayed by the system in response to a user selecting a playlist.

FIG. 10 illustrates an example screen displayed by the system if the user selects the menu button on the remote control within the context of a Playlist screen.

FIG. 11 illustrates an example screen displayed by the system in response to the user selecting with the select key the menu item “Change View” from the edit menu of FIG. 10.

FIG. 12 illustrates an example screen displayed by the system in response to the selection of the genres item.

FIG. 13 illustrates an example screen displayed by the system in response to the user selection of the genre “Classical” from the screen of FIG. 12.

FIG. 14 illustrates an example screen displayed by the system in response to a user selecting the item “all albums” from the “Classical” genre.

FIG. 15 illustrates an example screen displayed by the system in response to a user selecting the “All Tracks” item within a genre.

FIG. 16 illustrates an example screen displayed by the system in response to the user's selection of the artist “Alexandria Kleatat” from the Classical genre screen.

FIG. 17 illustrates an example screen displayed by the system in response to the user selection of the item “All Tracks” within the artist-genre classification.

FIG. 18 illustrates an example screen for the genre, artists, album sequence.

FIG. 19 illustrates an example screen displayed by the system if the user selects the menu button on the remote control within the context of a genres screen.

FIG. 20 illustrates an example screen displayed by the system in response to the user selecting with the select key the menu item “Genre Information” from the edit menu of FIG. 19.

FIG. 21 illustrates an example screen for displaying artists in the music jukebox application.

FIG. 22 illustrates an example screen displayed by the system in response to the user's selection of an artist.

FIG. 23 illustrates an example screen that displays albums for the music jukebox application.

FIG. 24 illustrates an example screen displayed in response to the user's selection of an album.

FIG. 25 illustrates an example screen that displays tracks for the music jukebox application.

FIG. 26 illustrates an example screen displayed by the system if the user selects the menu button on the remote control within the context of an All Tracks screen.

FIG. 27 illustrates an example screen display for ripping an audio CD for the media convergence system.

FIG. 28 illustrates an example introduction screen for the photo albums application.

FIG. 29 illustrates an example screen displayed by the system in response to the user's selection of the photo album, people.

FIG. 30 illustrates an example screen displayed by the system if the user selects the menu button on the remote control within the context of the photo albums application.

FIG. 31a illustrates an example screen displayed by the system in response to the user's selection of the Photo Preferences function in the edit menu of FIG. 30.

FIG. 31b illustrates an example screen displayed by the system in response to the user selecting, using the selectable widgets approach, a time delay of “5 seconds.”

FIG. 32 illustrates an example screen displayed by the system in response to the user's selection of the Photo Information function in the edit menu of the photo albums application when a photo album has been selected.

FIG. 33 illustrates an example screen for the video clips application.

FIG. 34 illustrates an example screen displayed by the system in response to the user selection of the item “Movies” from the screen of FIG. 33.

FIG. 35 illustrates an example introduction screen for the Internet content application.

FIG. 36 illustrates an example screen for the display of content from the Internet content provider, “The Feed room.”

FIG. 37 illustrates an example screen displayed by the system if the user selects the menu button on the remote control within the context of the top-level or introduction screen.

FIG. 38 illustrates one embodiment for a screen displayed by the system in response to a user selection of the “System Preferences” menu item of FIG. 37.

FIG. 39 illustrates an example screen displayed by the system to set parameters for Network preferences.

### DETAILED DESCRIPTION

Media Convergence Platform:

The user interface of the present invention provides an efficient and easy way for one or more users to manage and playback media within a “media space.” As used herein, a “media space” connotes one or more media storage devices coupled to one or more media players for use by one or more users. The integration of media storage devices and media players into a single media space permits centralized management and control of content available within the media space.

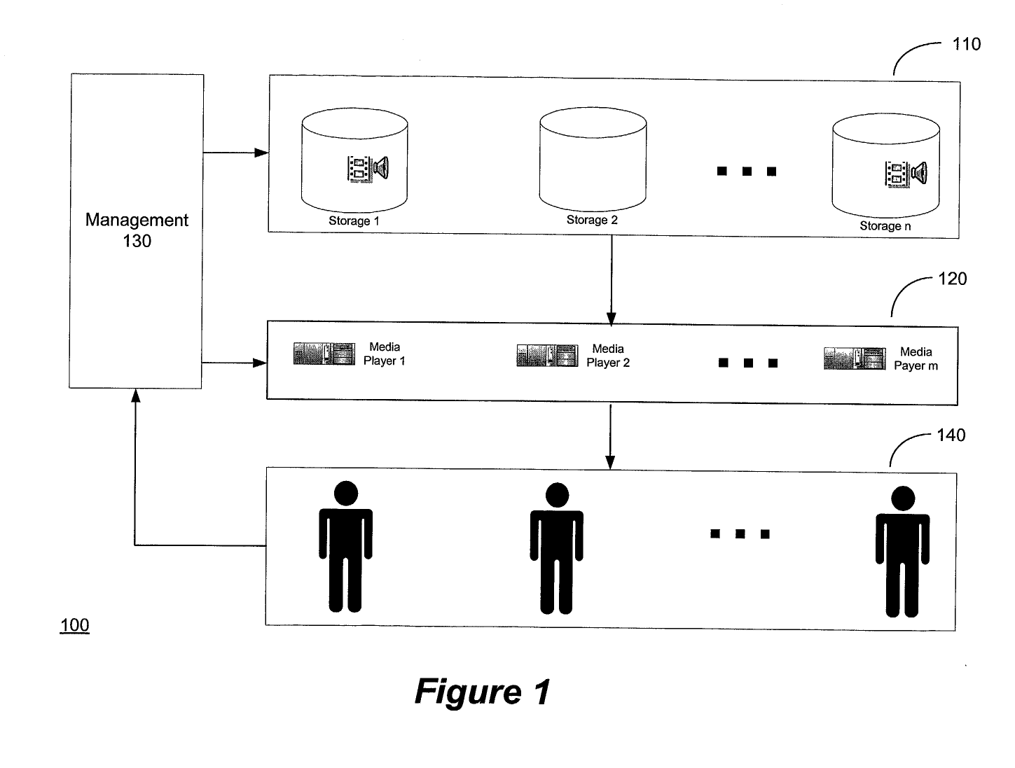

FIG. 1 illustrates a media space configured in accordance with one embodiment of the present invention. As shown in FIG. 1, the media space 100 includes “n” media storage devices 110, where “n” is any integer value greater than or equal to one. The media storage devices 110 store any type of media. In one embodiment, the media storage devices 110 store digital media, such as digital audio, digital video (e.g., DVD, MPEG, etc.), and digital images. The media space 100 also includes “m” media players 120, where “m” is any integer value greater than or equal to one. In general, the media players 120 are devices suitable for playing and or viewing various types of media. For example, a media player may comprise a stereo system for playing music or a television for playing DVDs or viewing digital photos.

As shown in FIG. 1, the media storage devices 110 are coupled to the media players 120. The media storage devices 110 and the media players 120 are shown in FIG. 1 as separate devices to depict the separate functions of media storage and media playback; however, the media players may perform both the storage and playback functions. For example, a media player may comprise a DVD player that includes a hard drive for the storage and playback of digital video. In other embodiments, the storage of media and the playback/viewing of media are performed by separate devices. For this embodiment, the media players 120 playback content stored on the media storage devices 110. For example, a video clip stored on media storage device “1” may be played on any of the applicable “m” media players 120.

The storage devices 110 and media players 120 are controlled by management component 130. In general, management component 130 permits users to organize, control (e.g., add, delete or modify), browse, and playback media available within the media space 100. The media space of FIG. 1 shows a plurality of users 140 to depict that more than one user may playback/view media through different media players. The system supports playback of different media through multiple media players (i.e., the system provides multiple streams of media simultaneously). The users 140, through management component 130, may also organize, control, and browse media available within the media space. The management component 130 provides a centralized means to manage and control all media within the media space.

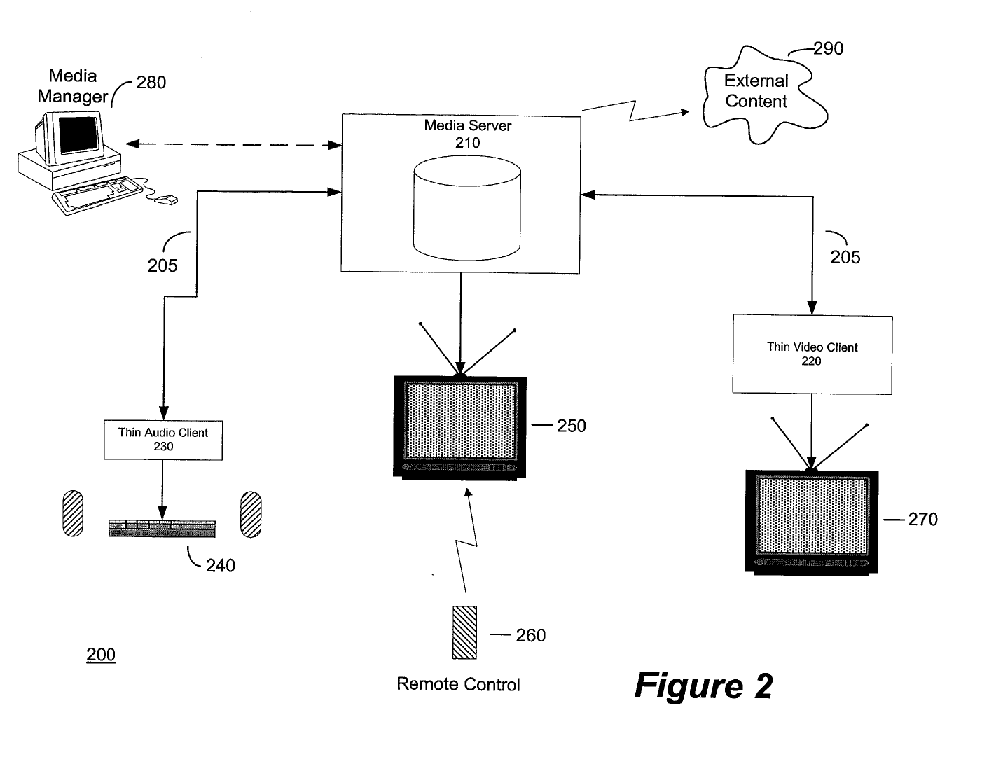

FIG. 2 illustrates one embodiment for integrating devices into a single media space. For this embodiment, a media space 200 includes a media server 210. The media server 210 stores media for distribution throughout the media space 200. In addition, the media server 210 stores system software to integrate the components of the media space, to distribute media through the media space, and to provide a user interface for the components of the media space. The media server 210 is coupled to different types of media players, including televisions 250 and 270, as well as an audio player 240 (e.g., stereo system). For this embodiment, the media server 210 is also coupled to a media manager 280 and to external content provider(s) 290.

For this embodiment, the media server 210 executes software to perform a variety of functions within the media space. Thus, in this configuration, the media server 210 operates as a “thick client.” A user accesses and controls the functions of the media convergence platform through a system user interface. The user interface utilizes the thick and thin clients, as well as some media players (e.g., televisions 250 & 270). In one embodiment, the user interface includes a plurality of interactive screens displayed on media player output devices to permit a user to access the functionality of the system. A screen of the user interface includes one or more items for selection by a user. The user navigates through the user interface using a remote control device (e.g., remote control 260). The user, through use of a remote control, controls the display of screens in the user interface and selects items displayed on the screens. As described more fully below, a user interface displayed on a television permits the user, using a remote control, to perform a variety of functions pertaining to the media available in the media space.

The components of the media convergence platform are integrated through a network. For example, in the embodiment of FIG. 2, media server 210 communicates to thin audio client 230 and thin video client 220 through network 205. Network 205 may comprise any type of network, including wireless networks. For example, network 205 may comprise networks implemented in accordance with standards, such as Ethernet 10/100 on Category 5, HPNA, Home Plug, IEEE 802.11x, 1394, and USB 1.1/2.0.

For the embodiment of FIG. 2, one or more thin video clients are integrated into the media space. Specifically, a thin video client 220 is coupled to media server 210 to provide playback of digital media on television 270. The thin video client 220 does not store media. Instead, the thin video client 270 receives media from media server 210, and processes the media for display or playback on television 270 (e.g., a standard television). For example, media server 210 transmits a digital movie over network 205, and the thin video client processes the digital movie for display on television 270. In one embodiment, the thin video client 220 processes the digital movie “on the fly” to provide NTSC or PAL formatted video for playback on television 270. The thin video client 220 may be integrated into the television 270. In one embodiment, a user interface is implemented using media server 210 and thin video client 220 for display on television 270. For this embodiment, the user, using a remote control for television 270, selects items displayed on television 270 to command the system.

The media convergence platform system also integrates one or more thin audio clients into the media space. For the embodiment of FIG. 2, a thin audio client 230 receives digital music (e.g., MP3 format) from media server 210 over network 205, and processes the digital music for playback on a standard audio system 240. In one embodiment, the thin audio client 210 includes a small display (e.g., liquid crystal display “LCD”) and buttons for use as a user interface. The media server 210 transmits items and identifiers for the items for display on the thin audio client 230. For example, the thin audio client 230 may display lists of tracks for playback on audio system 240. The user selects items displayed on the screen using the buttons to command the system. For example, the thin audio client screen may display a list of albums available in the media space, and the user, through use of the buttons, may command the user interface to display a list of tracks for a selected album. Then, the user may select a track displayed on the screen for playback on audio system 240.

The media manager 280 is an optional component for the media convergence platform system. In general, the media manager 280 permits the user to organize, download, and edit media in the personal computer “PC” environment. The media manager may store media for integration into the media space (i.e., store media for use by other components in the media space). In one embodiment, the media manger 280 permits the user to perform system functions on a PC that are less suitable for implementation on a television based user interface.

The media space may be extended to access media stored external to those components located in the same general physical proximity (e.g., a house). In one embodiment, the media convergence platform system integrates content from external sources into the media space. For example, as shown in FIG. 2, the media server 210 may access content external to the local network 205. The external content may include any type of media, such as digital music and video. The media convergence platform system may be coupled to external content 290 through a broadband connection (i.e., high bandwidth communications link) to permit downloading of media rich content. The external content may be delivered to the media convergence platform system through use of the Internet, or the external content may be delivered through use of private distribution networks. For example, the media server 210 may access external content 290 through a data casting service (i.e., data modulated and broadcast using RF, microwave, or satellite technology).

Overview of the Media Convergence Platform User Interface:

The overall design and presentation of the media convergence platform user interface is television centric. A television centric user interface permits the user to navigate the media convergence platform system with a television experience. A television user interface has inherently different properties than a computer based user interface. In a computer-based interface, screen resolution is greater than screen resolution on a television (i.e., NTSC or PAL formats). The user of a computer uses a mouse to precisely control the position of the cursor on the computer output display. In contrast, the user of a television user interface moves a highlighted bar across the screen to select items from a list. Recognizing these inherent differences, the design of the media convergence platform system user interface maximizes the user interface for a television. For example, to maximize the user interface for a television, the font size of the text is sufficiently large for viewing on a television. In addition, the separation between items on the television display provides clarity for easy selection by the user. The use of icons in the user interface is minimized so as to prevent an overabundance of information displayed on the television.

In one embodiment, the user interacts with the media convergence platform system using a remote control device (e.g., a television remote control). The remote control device includes, at a minimum, buttons or keys that move a cursor to highlight items on the television screen. The keys on the remote may also be used to select items highlighted on the screen. In one embodiment, the keys include a plurality of directional keys. Specifically, the remote control keys are oriented, in a clockwise direction, to include a top arrow key, a right arrow key, a bottom arrow key and a left arrow key. The remote control also has a select key, located in the center of the directional keys. As used herein, the directional and select keys on the remote control are referred to as “cursor control keys.”

In one embodiment, the user is permitted to command the system to perform a wide range of functions using only the cursor control keys. In general, the right cursor control key is used to descend into the contents of an item. In the event that an item does not have any items beneath it, the right cursor control key may be used to playback the item in a media player. The center cursor control key functions to select the item. The pressing of the center cursor control key may cause the system to descend, play, or change the selection depending on the context within the UI. The left cursor control key is generally used to exit the existing screen to access the previously displayed screen. The top and down cursor keys move the cursor in a vertical direction. Typically, the up/down cursor control keys are used to scroll through lists of items displayed on the screen.

In general, to implement the user interface, the system displays a plurality of screens on a television. In general, a screen contains, in a title portion of the screen, identifier information followed by a list of items for selection by the user as well as a contextual help section. The title information identifies the items, organization of the items, and/or the current application. The contextual help section displays help text to aid the user in navigation of the system. In addition, the system displays arrows for items highlighted on the screen to inform the user which cursor control keys are valid for input. For example, a right arrow (>) displayed for a selected item indicates that the right cursor control key is a valid option for that item.

The television based user interface for the media convergence platform may be characterized as having two levels of operation. A first level provides a mechanism for the user to conduct the basic functionality within the system. For example, from the first level, a user may browse items that identify media and select items for playback in an appropriate media player. The second level within the user interface provides the user more features, although requires a slightly higher level of user competence than the first level. Example features offered in the second level of the user interface include a menu button and a status button. The status feature allows the user to view the status of multiple aspects of the media convergence system. The edit menu provides context sensitive screens to allow the user to modify aspects of the system.

In another embodiment, the media convergence platform system operates in conjunction with a personal computer tool, referred to herein as the media manager (FIG. 2). The media manager implements a third level of functionality for the user interface. The third level of the user interface, which requires more detailed actions by the user, is more appropriate for implementation on a computer than on a television. For example, some functions implemented in the third level of functionality include organizing music into categories, rotating photographs, and reducing red eye affects in digital photography. Thus, for this embodiment, a user of the media convergence platform system uses a computer to perform those functions best implemented in a computer based user interface.

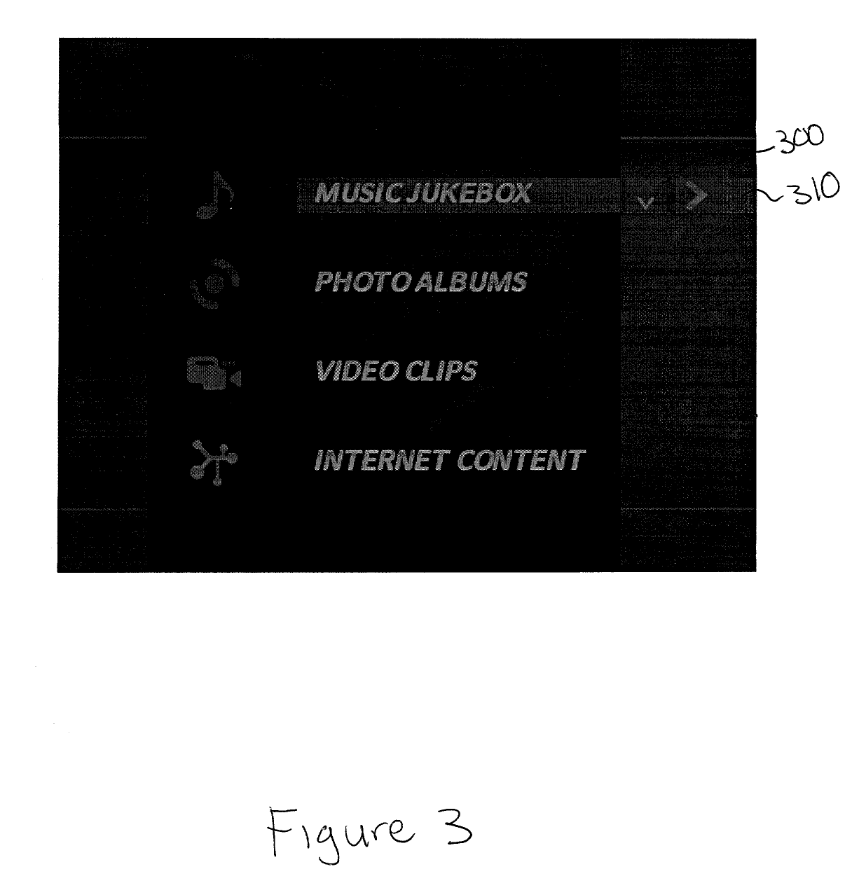

The user interface for the media convergence platform system integrates, in a single user interface, a variety of functions for different types of media. In one embodiment, the user interface integrates applications for digital photos, video clips, music and streaming content from external sources (e.g., the Internet). FIG. 3 illustrates an example screen of a top-level or introduction screen for the user interface. The top-level or introduction screen is a presentation to the user that permits the user to access a variety of applications in the media convergence system. For the embodiment of FIG. 3, the user interface presents a music jukebox, photo album, video clip and Internet content applications. From this screen, a user, with the remote control cursor keys, is permitted to scroll up and down the application menu items (i.e., music jukebox, photo album, video clip, and Internet content). The item currently selected is highlighted, such as through use of color or luminance that contrasts with the background of the screen. The example screen of FIG. 3 depicts that the “music jukebox” is the currently selected application (i.e., the music jukebox item is highlighted in FIG. 3). Also, for the example display of FIG. 3, the down arrow is displayed in box 300 to indicate to the user that the user may scroll down the items towards the photo albums application. Also, as indicated in box 310, the user may press the right cursor control key to enter the music jukebox application. The center cursor control key, if pressed by the user, “selects” the music jukebox application (i.e., the center cursor control key has the same result as the right cursor control key).

Music Jukebox:

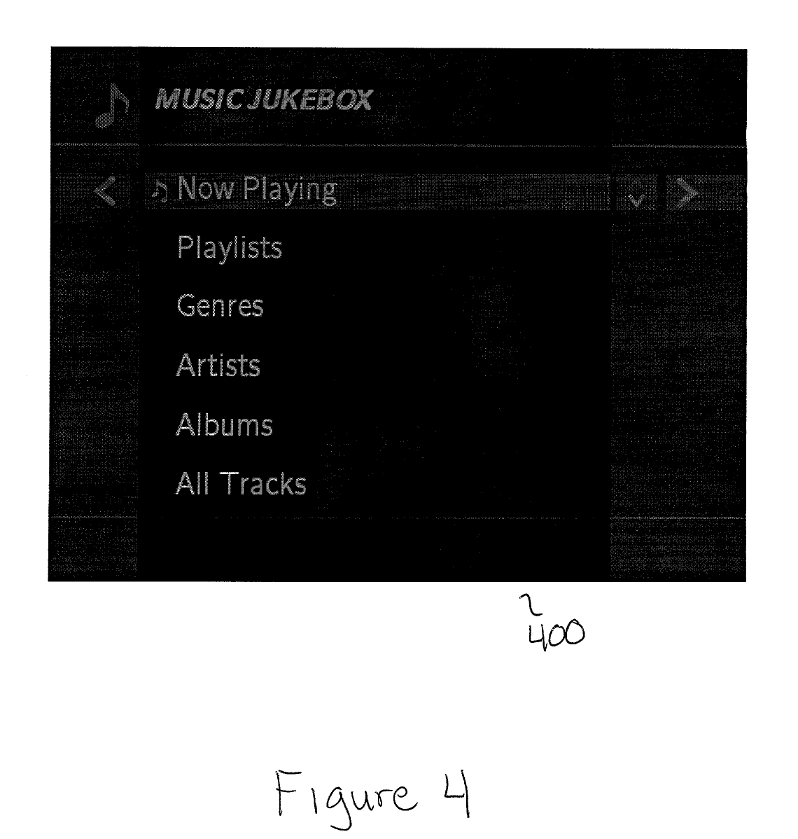

If the user selects the music jukebox application from the top-level screen, the user interface displays an introduction screen for the music jukebox application. FIG. 4 illustrates an example introductory screen for the music jukebox application. In part, the music jukebox application screen shows the user ways in which music may be organized in the media convergence platform system. In general, the introduction screen displays a plurality of menu items to permit the user to browse, organize, and playback music available within the media space. For this embodiment, the menu items include “Now Playing”, “Playlists”, “Genres”, “Artists”, “Albums”, and “All Tracks.”

In one embodiment, the media convergence platform system is implemented using a database. In general, the database stores objects, attributes associated with those objects, and associations between those objects. For example, the database stores an identification of musical tracks available within the media space. The database stores a plurality of attributes, so as to associate one or more attributes for each musical track. In one embodiment, the objects include albums, artists, tracks, genres, and playlists. Thus, a track may be associated with one or more albums, one or more artists, one or more genres, and one or more playlists. Attributes include titles, creation dates, and multiple associated media files. Thus, a track may have associated album art, lyrics, etc.

The media convergence platform database permits classifying audio tracks in an extremely versatile manner. For example, a user may desire to classify a track or album (i.e., collection of tracks) in more than one genre because the user associates the music with two different types of genres (e.g., rock and blues). Also, a musical track may be a result of a collaboration between two artists. To properly classify the track, a user of the media convergence platform may associate the track with two different artists. As illustrated by the above examples, the media convergence platform system provides maximum flexibility in classifying and organizing music.

The media convergence platform system handles each classification or item as a distinct object. For example, for the music jukebox application, playlists, genres, artists, albums, and tracks are all handled as individual objects. This feature, which supports independent objects for organization and classification of items, provides maximum flexibility in organizing and classifying music. For example, the user may create nested playlists, such that a first playlist may be wholly contained within a second playlist. Prior art music systems only deal with playlists by tracks. For these prior art systems, a playlist only consists of tracks. In the media convergence platform system, playlists may comprise any “objects.” Therefore, playlists may be created from one or more artists, genres, albums or other playlists.

The use of objects in organizing and playing music also permits artists with the same name to be treated differently. Prior art digital music systems store metadata to identify artists. If a user executes a search on the metadata using these prior art systems, there is no way for the system to differentiate among artists with the same name. In the media convergence platform system, each artist is treated as an object. Thus, two artists with the same name are two distinct objects, and may be manipulated as two separate artists.

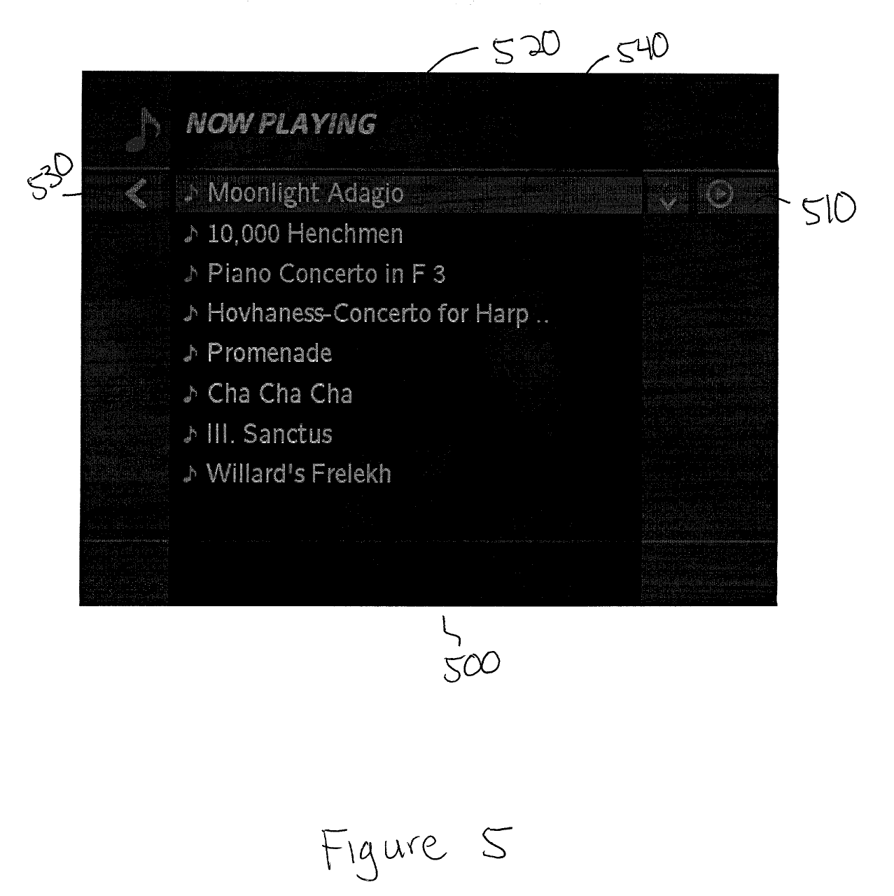

If the user selects the “Now Playing” function from the music jukebox introduction screen (FIG. 4), a now playing introduction screen is displayed. FIG. 5 illustrates an example screen for the “Now Playing” function. In general, the now playing screen displays the item currently playing, as well as those items queued for play. The “now playing” screen includes a title portion (520) that indicates that the now playing function has been selected. For the example screen shown in FIG. 5, the item “Moonlight Adagio” is currently playing within the media convergence platform system. The highlighted portion on the screen display (540) and an arrow encompassed by a circle (i.e., the play symbol) identifies that the item may be played (i.e., Moonlight Adagio may be played by the user). Also, for the example of FIG. 5, the tracks “10,000 Henchmen”, “Piano Concerto in F 3”, “Novhaness-Concerto for Harp . . . ”, Promenade”, “Cha Cha Cha”, “III. Sanctus”, and “Willards's Frelekh” are queued for subsequent play.

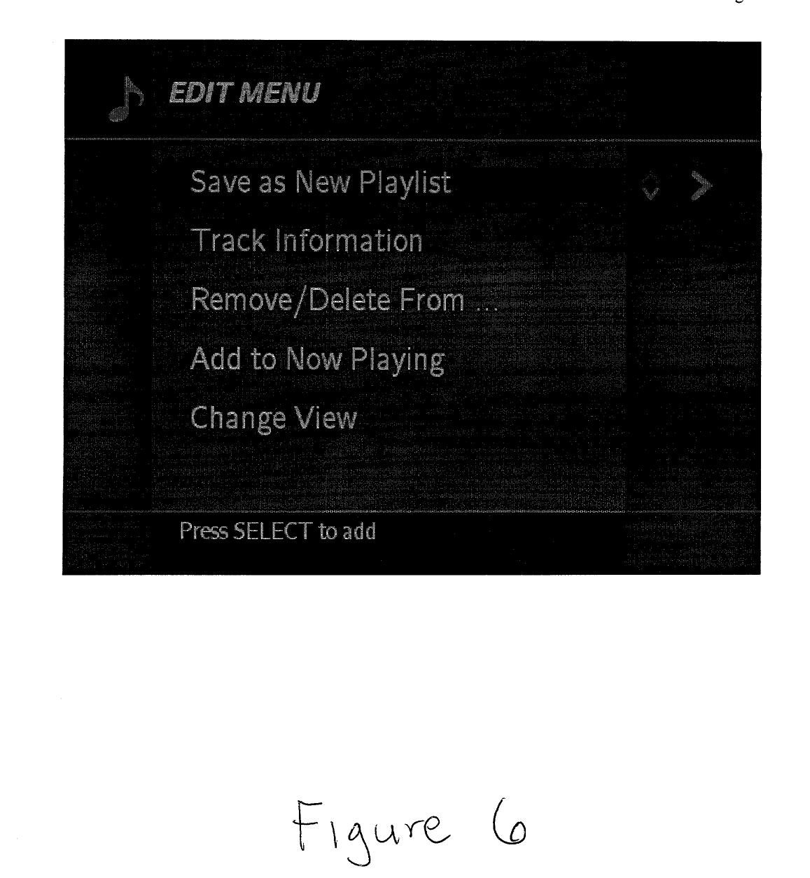

The user may invoke a second level user interface function (i.e., edit menu) from the “Now Playing” screen by selecting the menu button on the remote control. FIG. 6 illustrates an example screen displayed by the system if the user selects the menu button on the remote control. The edit menu in this context displays a plurality of menu items, including “Save as New Playlist”, “Track Information”, “Remove/Delete From . . . ”, “Add to Now Playing”, and “Change View.” To edit one of the menu items, the user highlights, with the remote control, a menu item, and selects the menu item by pressing right or select cursor control key.

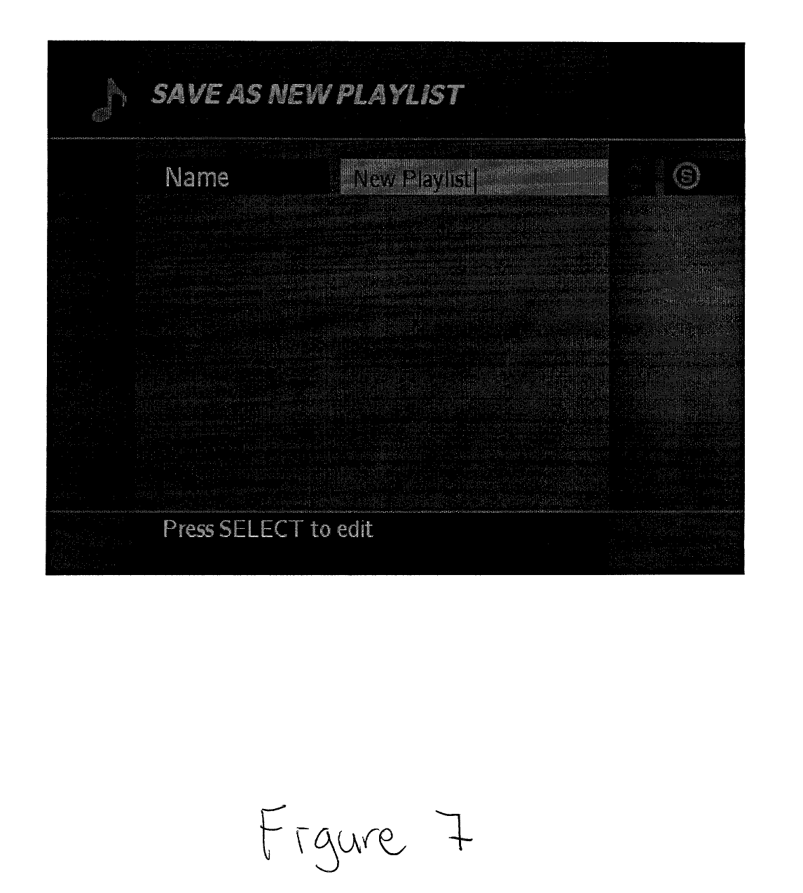

FIG. 7 illustrates an example screen displayed by the system in response to the user selecting the menu item “Save as New Playlist” from the edit menu of FIG. 6. In one embodiment, the system utilizes an open text field approach to edit an item. For the example of FIG. 7, the system displays an open text field in a color different than other colors used in the screen. For menu items utilizing the open text field approach, the user types information corresponding to the selected edit menu using the number/alphabet pad on the remote control (i.e., using the technique for entering letters and numbers from a telephone based keypad). For the example edit menu item “Save as New Playlist” shown in FIG. 7, the user types the name of the new playlist (e.g., “New Playlist”). The symbol S, encompassed by a circle, displayed on the screen signifies to the user that pressing the select button is a valid option. As part of the open text field approach, the user presses the select button on the remote control to confirm the newly added information. In response to the select command, the system changes the color of the open text field. The user may then press the menu button on the remote control to exit the edit menu of the user interface.

The “Track Information” function, displayed on the edit menu of FIG. 6, allows a user to enter information about a track. To edit “Track Information”, the user executes the open text field approach. If a user selects the “Remove/Delete From . . . ” edit menu item, the system displays objects associated with the Now Playing function. Using the “Remove/Delete From . . . ” edit menu item, objects may be selected and removed from “Now Playing.” If an object is removed, then the object is removed from the queue of media objects to be played. The “Add to Now Playing” edit menu item allows a user to add objects for the Now Playing function. In one embodiment, the system displays a taxonomy of objects for the music jukebox application (e.g., playlists, albums, tracks, etc.). The music jukebox application objects displayed are selectable widgets. Upon selecting multiple of these widgets, the system adds the selected media objects to the end of the Now Playing queue. The Change View function allows the user to change the sort order of objects in the Now Playing function. The selectable widgets associated with the Change View function include “As Is”, “Alphabetical”, and “Type.” At any point in these edit menus, the user may press menu again to return to the basic browse and playback mode of the system.

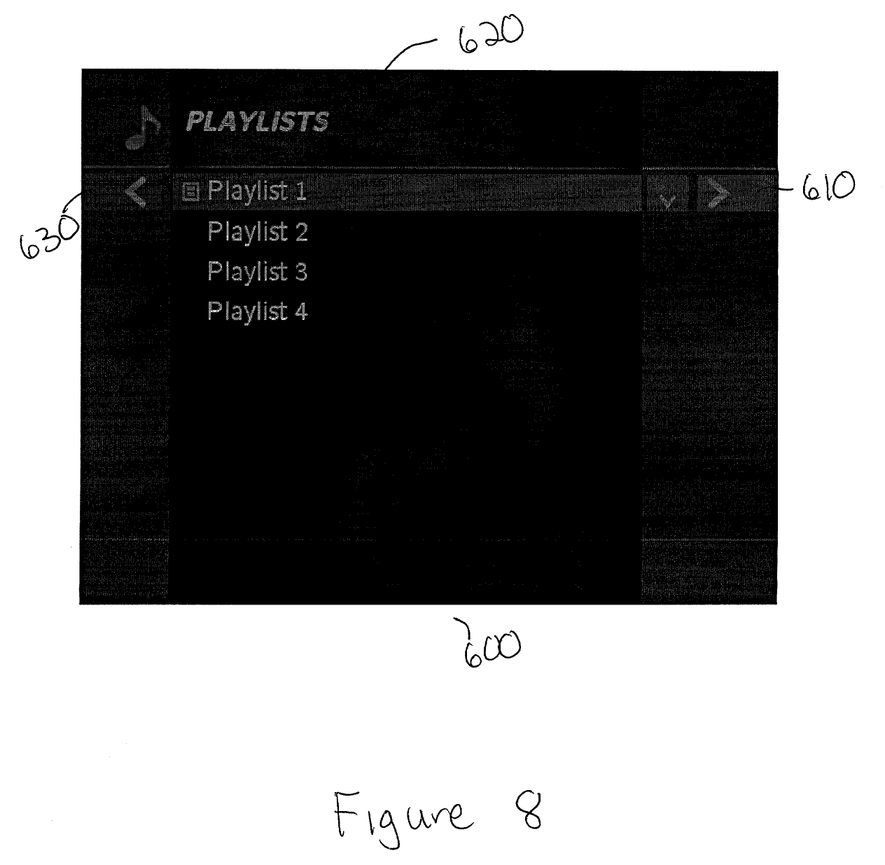

The user may select the playlists item from the music jukebox introduction screen (FIG. 4). In one embodiment, selection of the playlists item by a user causes the system to display a list of current playlists recognized by the system. FIG. 8 illustrates an example screen for displaying playlists. The playlists screen 600 includes a title portion 620 to indicate to the user that the menu items displayed below are playlists. The playlists screen 600 includes a left arrow in box 630 to indicate to the user that pressing the left arrow cursor control key is a valid option. Specifically, pressing the left cursor control key jumps the user back to the music jukebox introduction screen (FIG. 4). A right arrow, shown in box 610, provides the user with an indication that pressing the right cursor control or select key on the remote selects the highlighted item (e.g., playlist 1). For the example screen of FIG. 8, an icon is displayed next to “Playlist 1” to indicate to the user that Playlist 1 is currently selected.

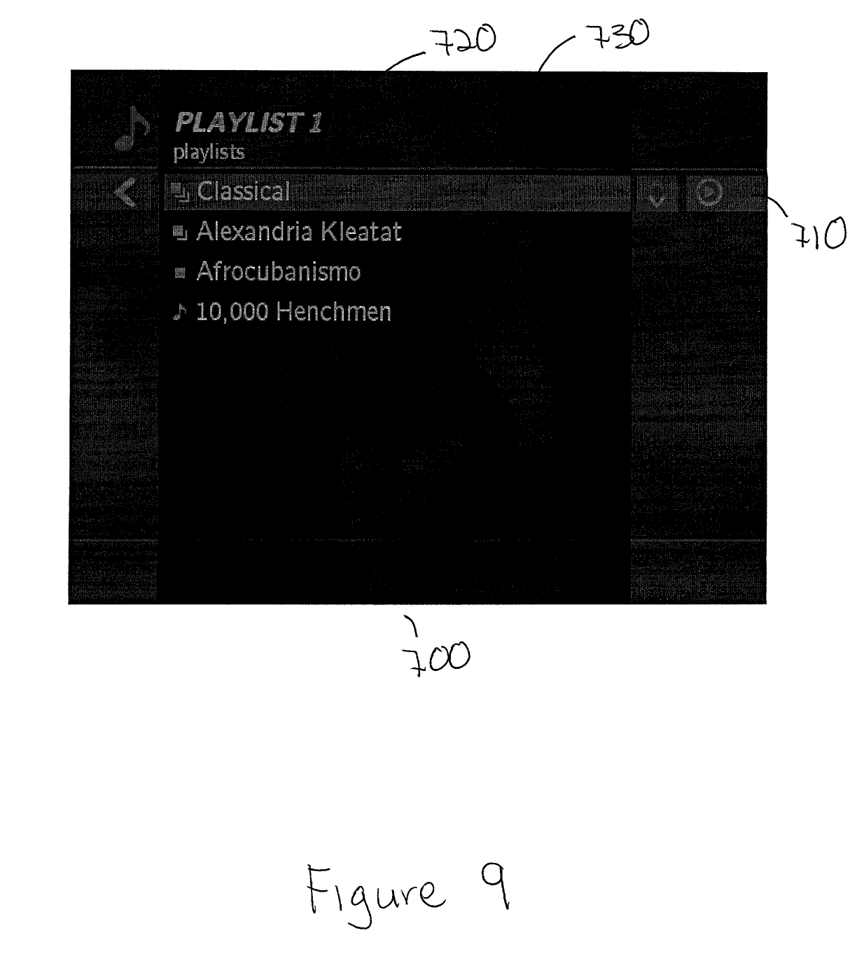

FIG. 9 is an example screen displayed by the system in response to a user selecting a playlist. For this example, the user selected “playlist 1” from screen display 600 (FIG. 8). In response to the user selection, screen 700 (FIG. 9) displays items contained within playlist 1. Specifically, for this example, playlist 1 includes the items “Classical”, “Alexandria Kleatat”, “Afrocubanismo”, and “10,000 Henchmen.” Note that the items within a playlist may consist of any type of audio object, such as genres, artists, albums, tracks, and other playlists. As indicated by the icons displayed next to the items, the item “Classical” is a genre, “Alexandria Kleatat” is an artist, “Afrocubanismo” is an album, and “10,000 Henchmen” is a track. The title block (720) indicates that playlist 1 has been selected. The item, “Classical”, is highlighted (block 730) to indicate that it is the currently selected item. The play symbol in block 710 indicates to the user that pressing the right arrow or select cursor control key prompts the system to play the item, Classical.

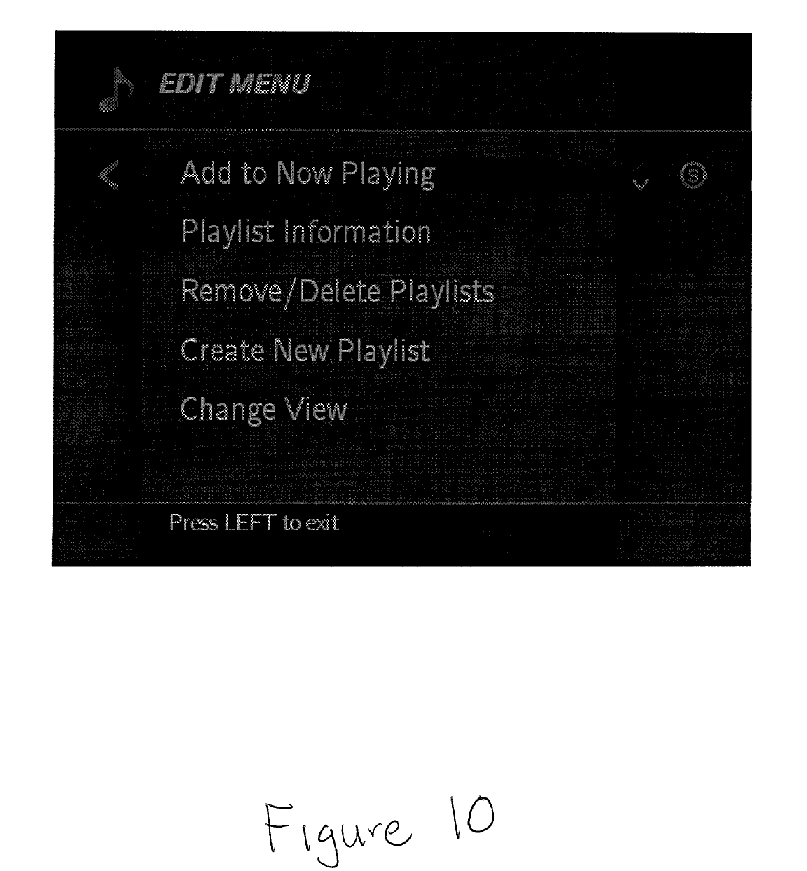

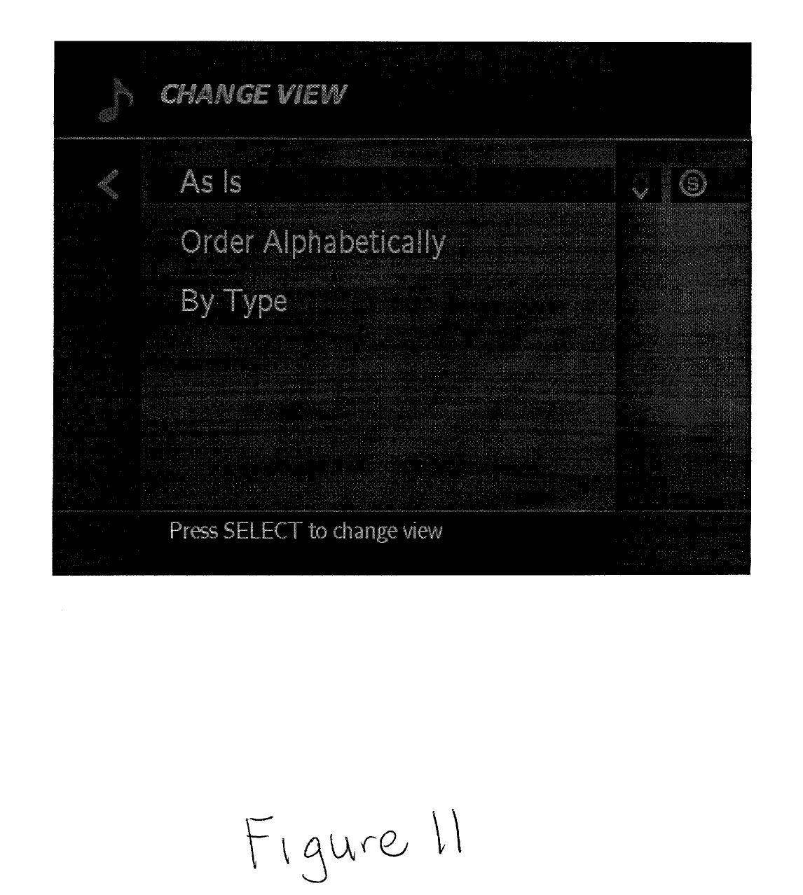

The user may invoke a second level user interface function (i.e., edit menu) from the “Playlist” screen by selecting the menu button on the remote control. FIG. 10 illustrates an example screen displayed by the system if the user selects the menu button on the remote control within the context of a Playlist screen. The edit menu in this context displays a plurality of menu items, including “Add to Now Playing”, “Playlist Information”, “Remove/Delete Playlists”, “Create New Playlist”, and “Change View.” To edit one of the menu items, the user highlights, with the remote control, a menu item, and selects the menu item. FIG. 11 illustrates an example screen displayed by the system in response to the user selecting with the select key the menu item “Change View” from the edit menu of FIG. 10. In one embodiment, the system utilizes scrollable items to edit an item. For menu items utilizing the scrollable items technique, the user scrolls through the list of items using the arrow keys on the remote control. The symbol S, encompassed by a circle, displayed on the Change View screen signifies to the user that pressing the select button is a valid option. The user then presses the select key to confirm the change in view. The “As Is” selection displays the relevant items (e.g., albums, tracks, etc.) in the order previously designated by the user. The “Order Alphabetically” item displays the relevant items alphabetically. The last item, “By Type”, when selected, commands the system to display the relevant items by genre, album, playlist, tracks, etc.

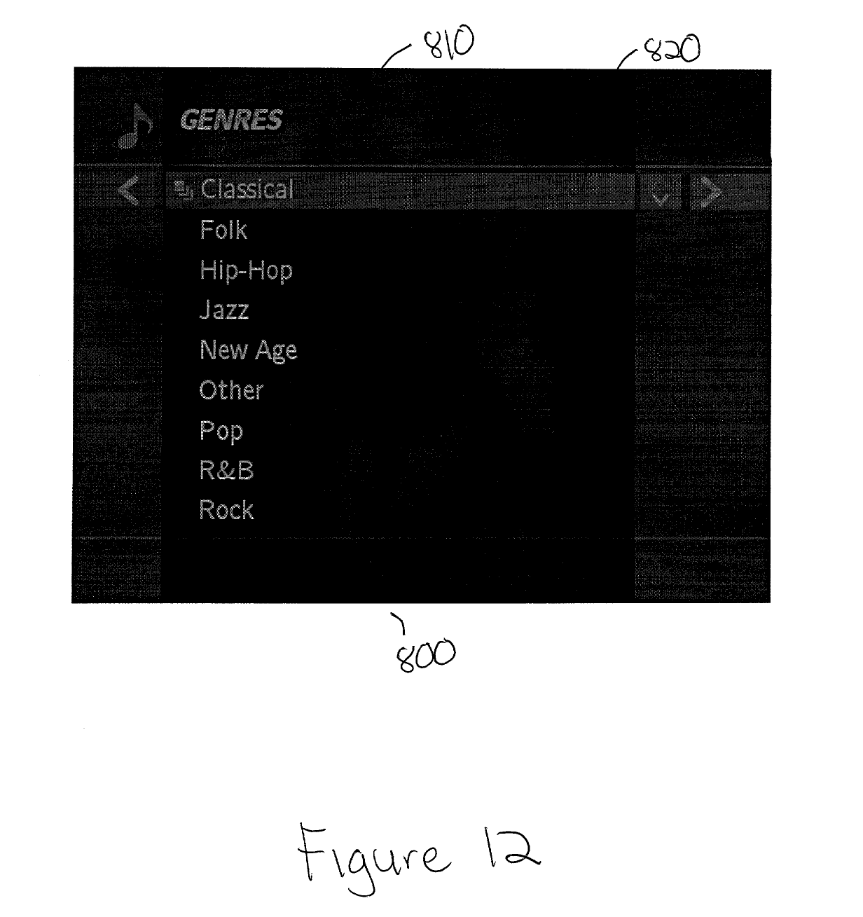

The introduction screen 400 (FIG. 4) for the music jukebox application permits the user to select the item “genres.” FIG. 12 illustrates an example screen displayed by the system in response to the selection of the genres item. In one embodiment, a list of genres is generated from the metadata when the audio is imported into the system or when a genre is created by the user. As shown in FIG. 12, a plurality of items, each representing a genre, are displayed. For this example, the system recognizes the genres “Classical”, “Folk”, “Hip-Hop”, “Jazz”, “New Age”, “Other”, “Pop”, “R&B”, and “Rock.” The title portion (810) identifies the items as “genres.” The current genre selected is highlighted by box 820. In one embodiment, the media convergence platform system presents, in response to a selection of a genre, artists, albums, and then tracks associated with the selected genre.

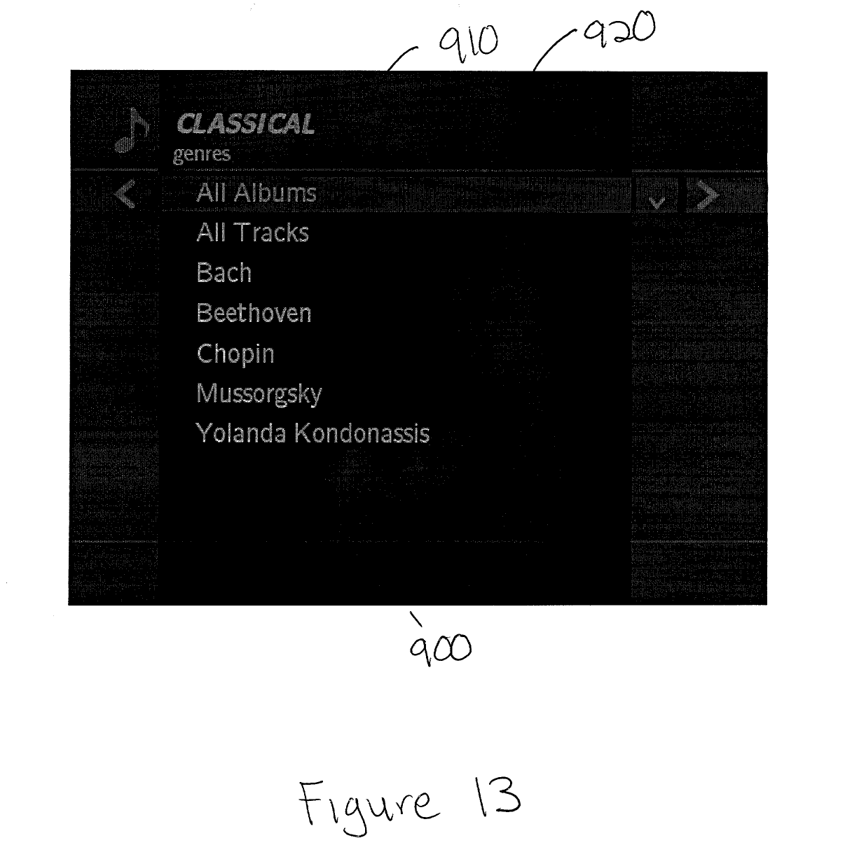

FIG. 13 illustrates an example screen displayed by the system in response to the user selection of the genre “Classical” from screen 800 (FIG. 12). For this example, screen 900 displays a plurality of items associated with the genre, “Classical.” The title portion 910 indicates to the user that the Classical genre has been selected. The menu items presented to the user include “All Albums” and “All Tracks.” The “All Albums” item, if selected, presents to the user all albums available within the media space classified in the genre, “Classical.” Similarly, the item “All Tracks”, if selected by the user, prompts the user to display all tracks classified in the Classical genre. In addition, all the artists classified in that genre are displayed.

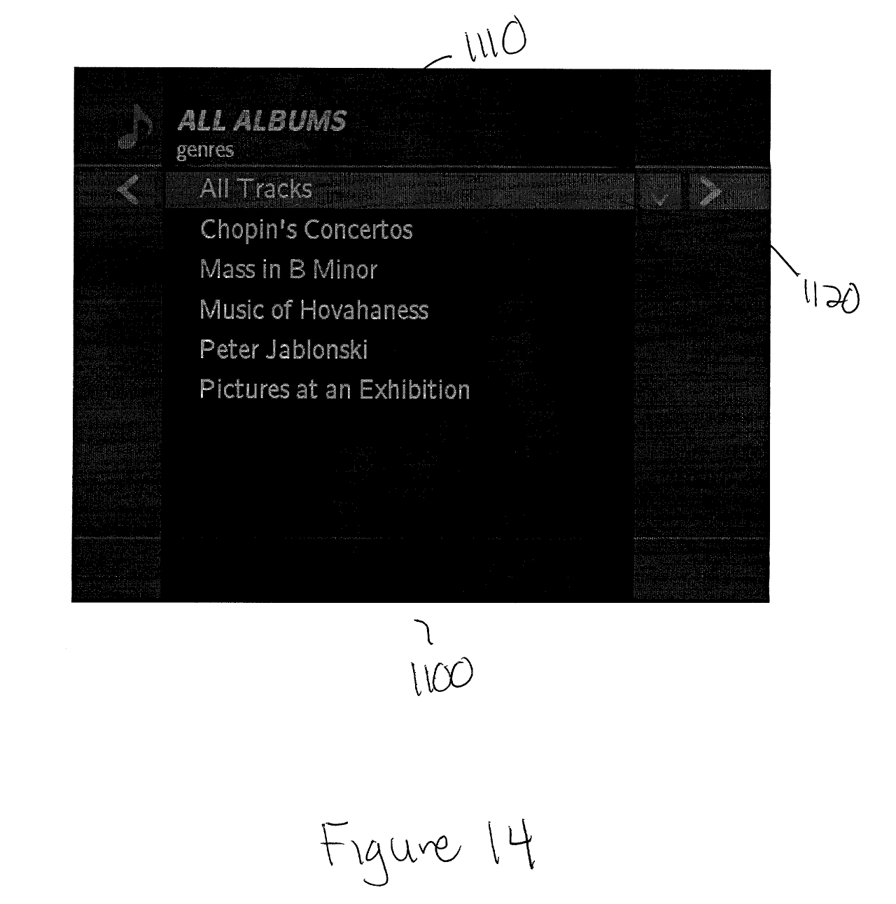

If the user selects the item “All Albums” from screen 900 (FIG. 13), then the system displays all albums classified in the selected genre. FIG. 14 illustrates an example screen displayed by the system in response to a user selecting the item “all albums” from the “Classical” genre. As shown in FIG. 14, in addition to displaying all albums classified in the Classical genre, screen 1100 also displays an item for “All Tracks.” The title portion of the screen (1110) displays the “all albums” item, and an indication that the albums are classified in the Classical genre. The “All Tracks” highlighted item includes a right arrow to indicate the user's option to select All Tracks.

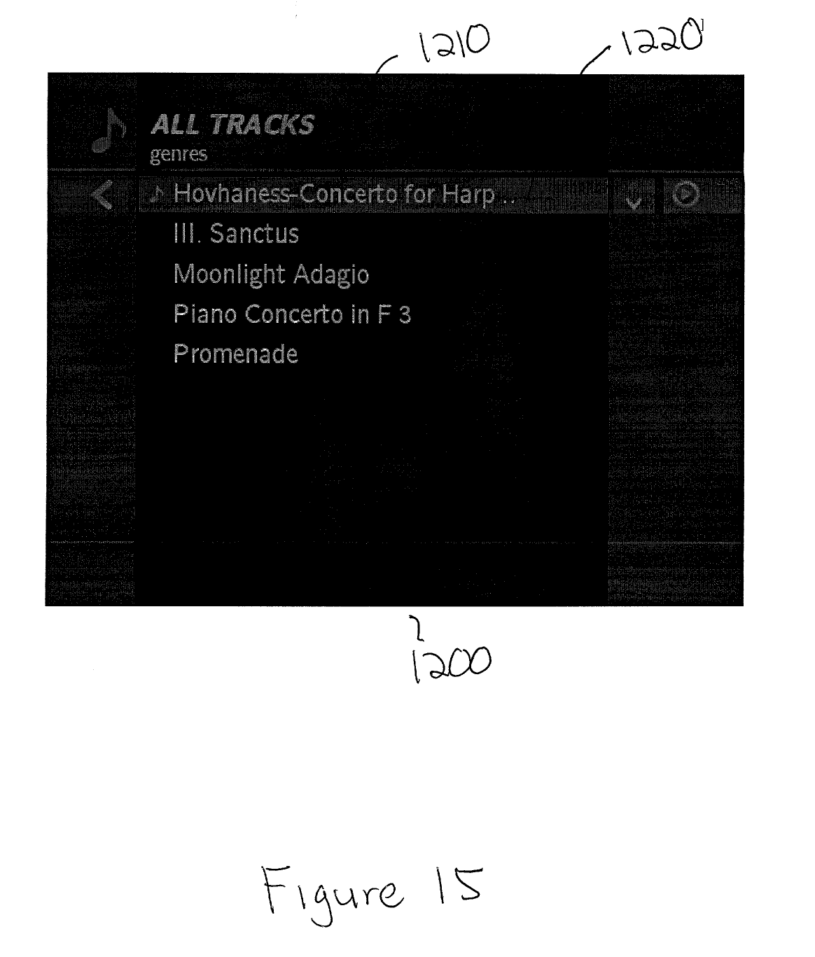

If the user selects the “All Tracks” item within the “all albums” genre hierarchy, all tracks classified in the genre are displayed. FIG. 15 illustrates an example screen displayed by the system in response to a user selecting the “All Tracks” item within the all albums/genre hierarchy. Specifically, for this example, screen 1200 displays all tracks classified in the Classical genre. The title portion of the screen (1210) displays “All Tracks” and “genres” to indicate to the user that the items in screen 1200 represent all tracks classified in the Classical genre. The highlighted track (1220) includes the play symbol to indicate to the user that pressing the right arrow cursor key, the select cursor key, or the play button on the remote control commands the system to play the highlighted track (e.g., Hovhaness-Concerto for Harp).

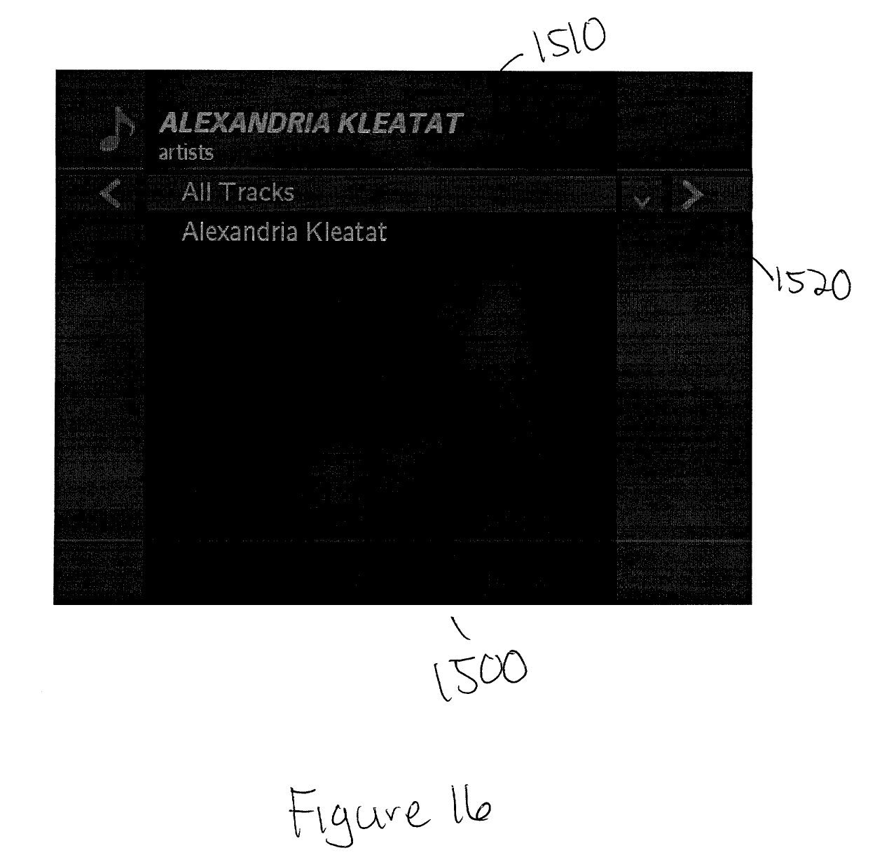

From a screen displaying the items for a selected genre, a user may select an artist. For example, from screen 900 (Classical genre), a user may select the artist “Alexandria Kleatat.” FIG. 16 illustrates an example screen displayed by the system in response to the user's selection of the artist “Alexandria Kleatat” from the Classical genre screen. The title portion of the screen (1510) displays the artist “Alexandria Kleatat.” For this embodiment, the items displayed include all albums for the selected artist (e.g., Alexandria Kleatat) as well as the item “All Tracks.” The highlighted item (1520), corresponding to “All Tracks”, includes a display of a right arrow to indicate to the user that the user may select the item to prompt the system to display all tracks corresponding to the artist in the selected genre.

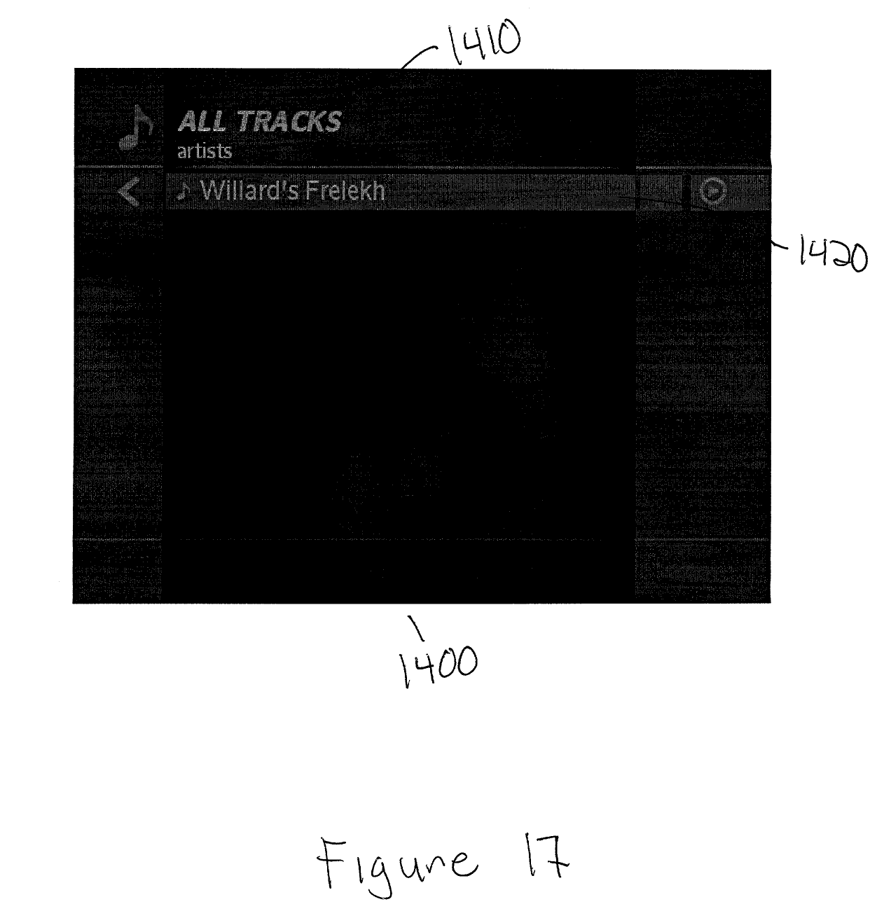

FIG. 17 illustrates an example screen displayed by the system in response to the user selection of the item “All Tracks” within the artist-genre classification. As shown in FIG. 17, the title portion of the display (1410) identifies the items as “All Tracks”, as well as the selected sequence “artists.” The highlighted track (1420) includes a display of the play symbol to indicate to the user that pressing the right arrow cursor, the select cursor control key, or the play button prompts the system to play the selected track.

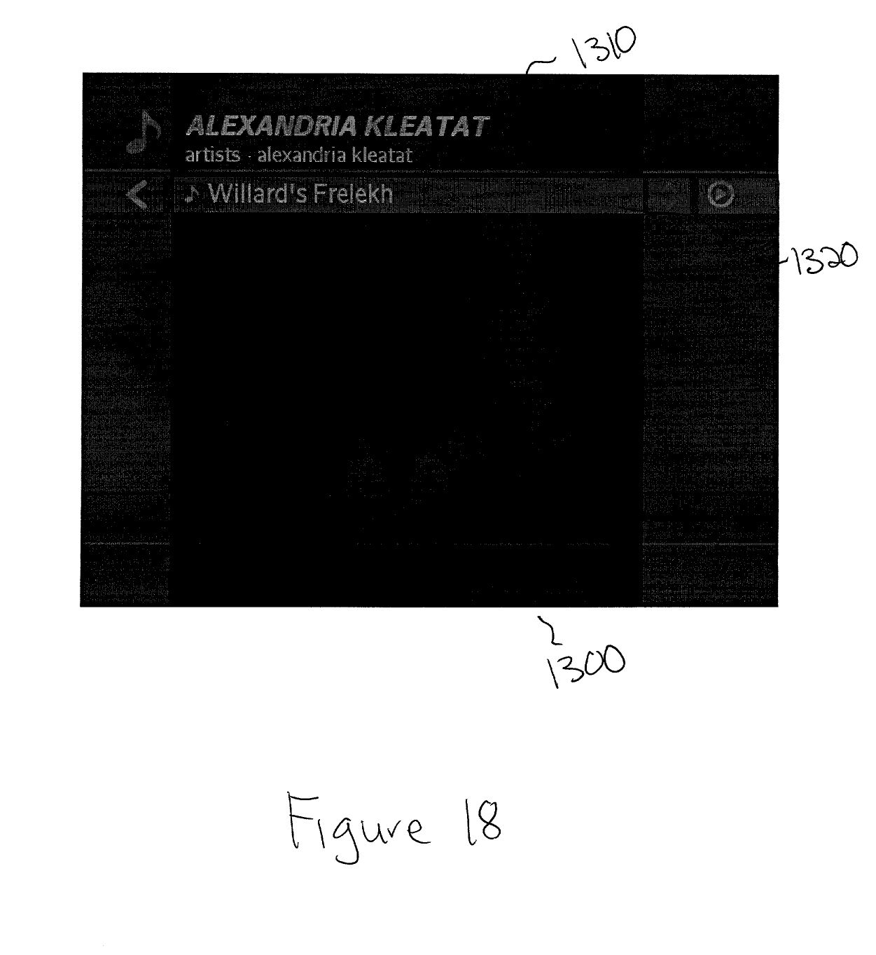

As shown in screen 900 (FIG. 13), the system displays, as an item, artists (e.g., “Bach”), for selection by the user. If the user selects an artist within a selected genre, then the system displays all albums classified in the selected genre for the selected artist. The user may then select an album, and in response, the system displays all tracks for the selected album. An example of this sequence of user selection (i.e., genre, artists, album) is illustrated in FIG. 18. Specifically, for this example, screen 1300 displays tracks associated with the artist “Alexandria Kleatat.” The highlighted track (1320) displays the play symbol to indicate to the user that pressing the right arrow cursor key, the select cursor control key, or the play button plays the highlighted track.

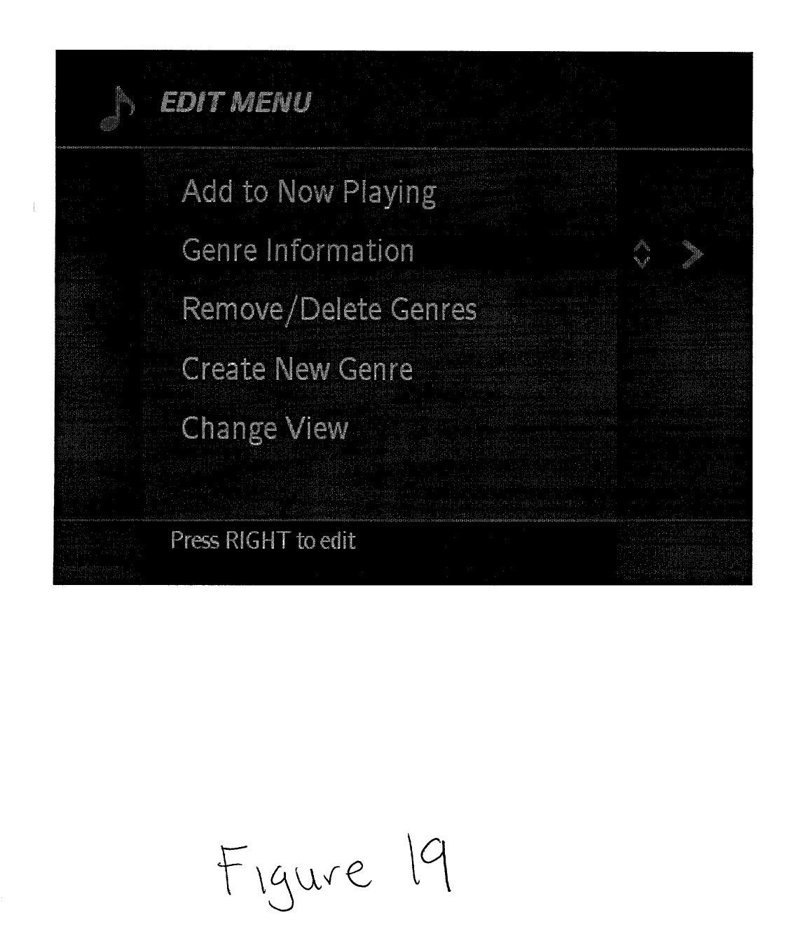

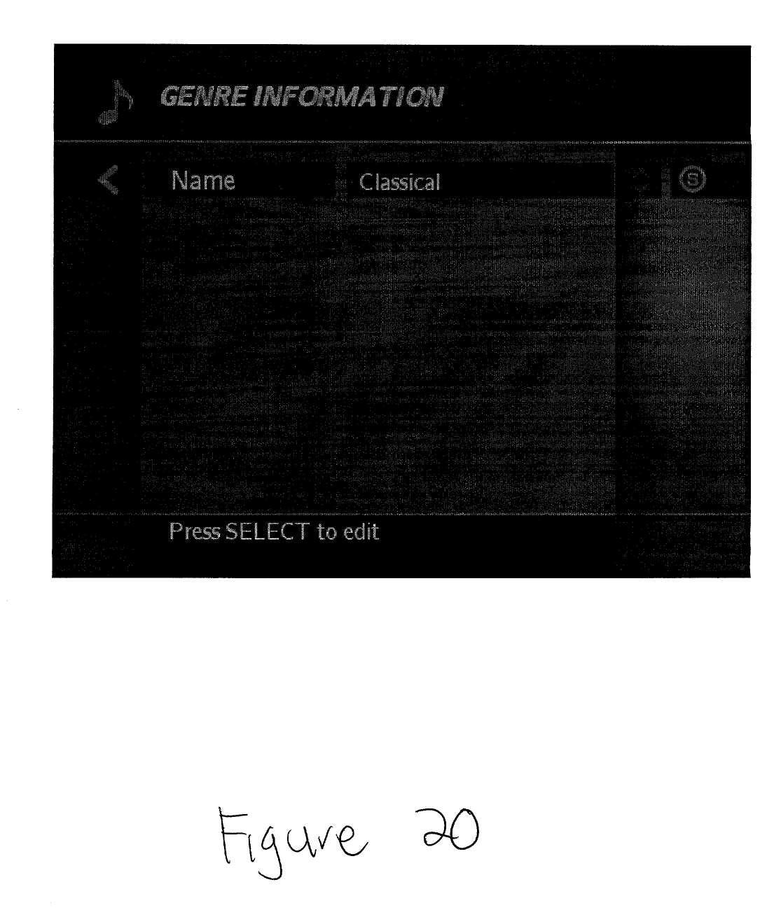

The user may invoke a second level user interface function (i.e., edit menu) from the any of the above screens by selecting the menu button on the remote control. FIG. 19 illustrates an example screen displayed by the system if the user selects the menu button on the remote control within the context of a genres screen. The edit menu in this context displays a plurality of menu items, including “Add to Now Playing”, “Genre Information”, “Remove/Delete Genres”, “Create New Genre”, and “Change View.” To edit one of the menu items, the user highlights, with the remote control, a menu item, and selects the menu item. FIG. 20 illustrates an example screen displayed by the system in response to the user selecting with the select key the menu item “Genre Information” from the edit menu of FIG. 19. For this embodiment, the system utilizes an open text field. The symbol S, encompassed by a circle, displayed on the Genre Information screen signifies to the user that pressing the select button is a valid option. The user then presses the select key to edit the genre information. After entering the genre information with the alphanumeric keypad on the remote control, the user presses select to confirm the genre information. The user may then press the menu button on the remote control to exit level two of the user interface. These same functions are also available to the user within the UI context of artists and albums if the user presses a menu button on a screen presenting those media types.

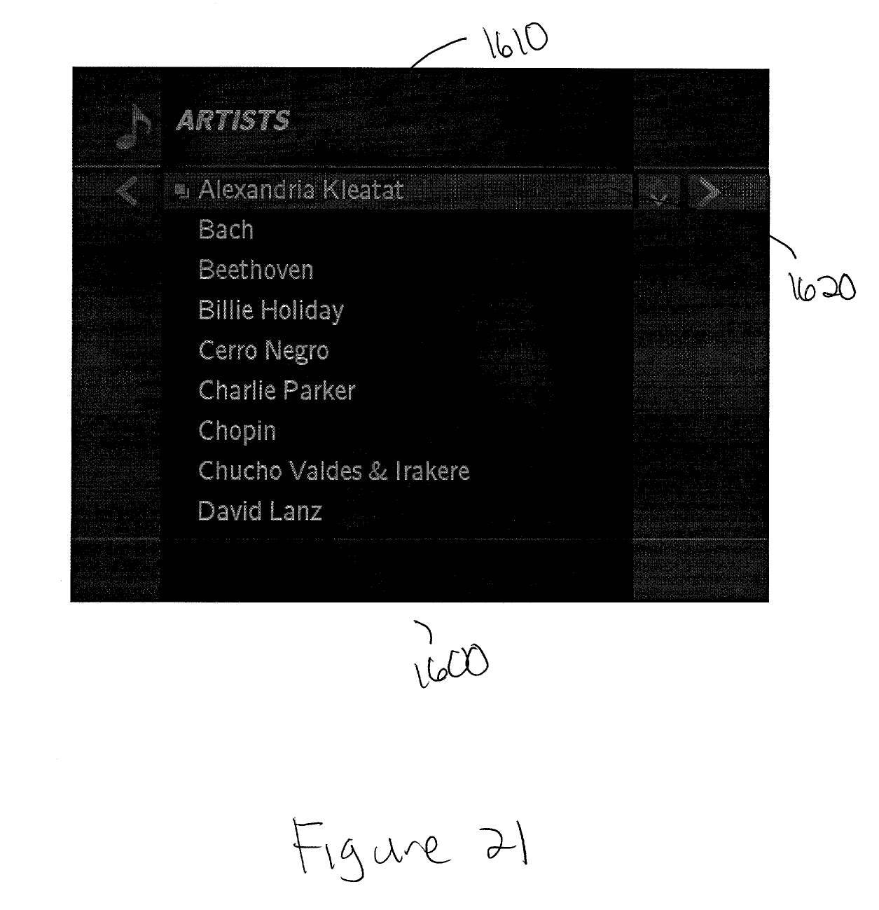

The music jukebox introduction screen 400 (FIG. 4) displays the item “artists.” If the user selects the item “artists”, the system displays all artists recognized by the system. FIG. 21 illustrates an example screen for displaying artists in the music jukebox application. Specifically, screen 1600 displays a list of items that indicate the artists recognized in the media space. The title portion of the screen (1610) displays “artists” to identify the items displayed below. The highlighted artist (1620) includes a display of the right arrow to indicate that the user may select the artist.

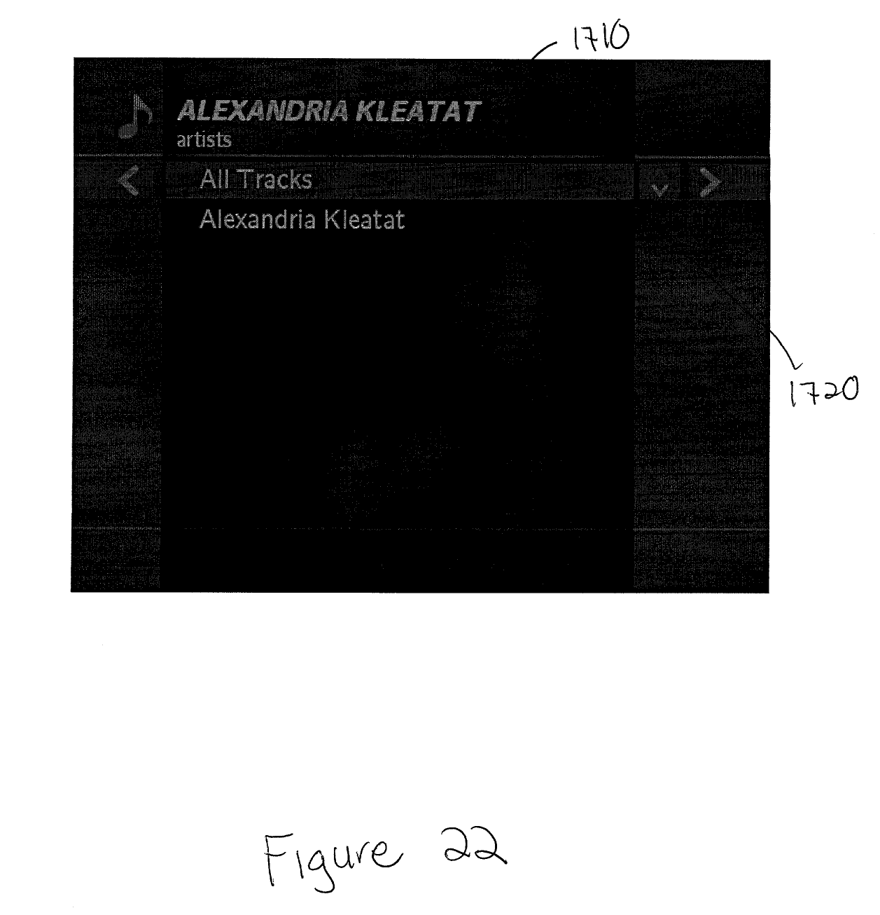

In response to the user selection of an artist, albums associated with the artist as well as the item “All Tracks” are displayed. FIG. 22 illustrates an example screen displayed by the system in response to the user's selection of an artist “Alexandria Kleatat”. As shown in FIG. 22, for this selection, the system displays all albums associated with the artist (e.g., Alexandria Kleatat) and the item “All Tracks.” The title portion of the screen (1710) displays the selected artist, Alexandria Kleatat, as well as the category, artists. If the user selects the highlighted item (1720), All Tracks, the system displays all tracks associated with the artist, Alexandria Kleatat.

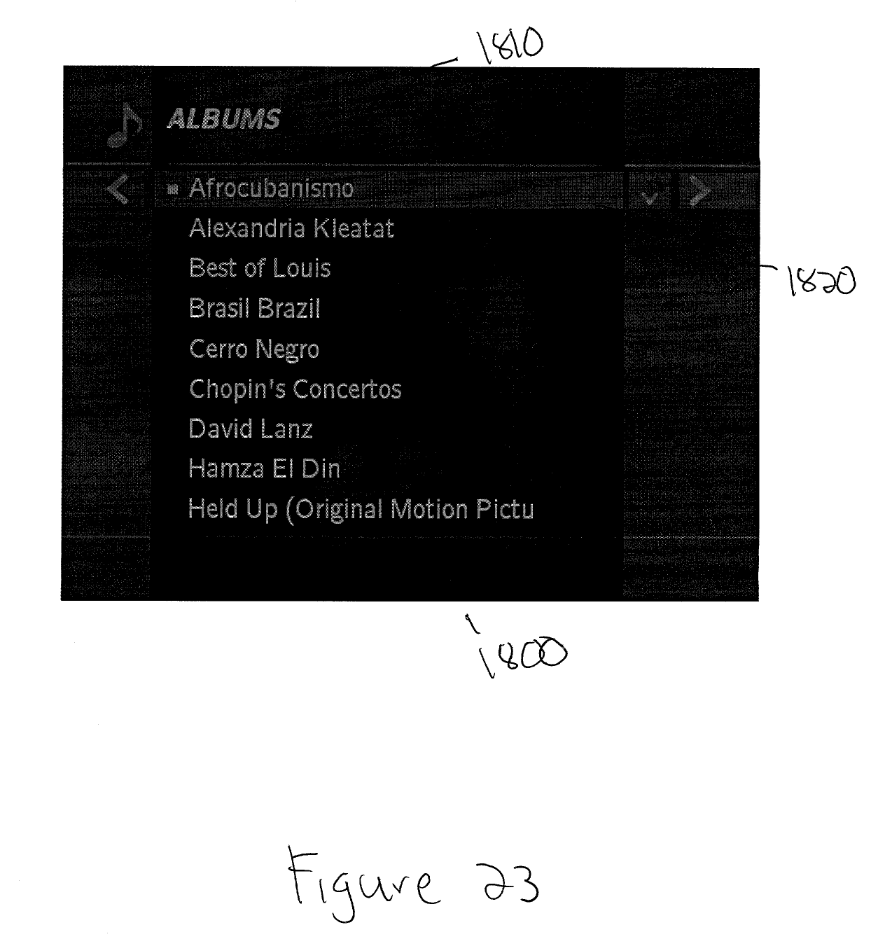

The introduction screen 400 for the music jukebox application (FIG. 4) displays the item “albums.” In response to a user's selection of the item “albums”, the system displays all available albums. FIG. 23 illustrates an example screen that displays albums for the music jukebox application. A screen 1800 includes the title portion (1810) that displays an indication for the corresponding items (i.e., the items are albums). If the user selects a highlighted album (e.g., Afrocubanismo), by pressing the right arrow or select cursor control key on the remote, the system displays all tracks for the selected album.

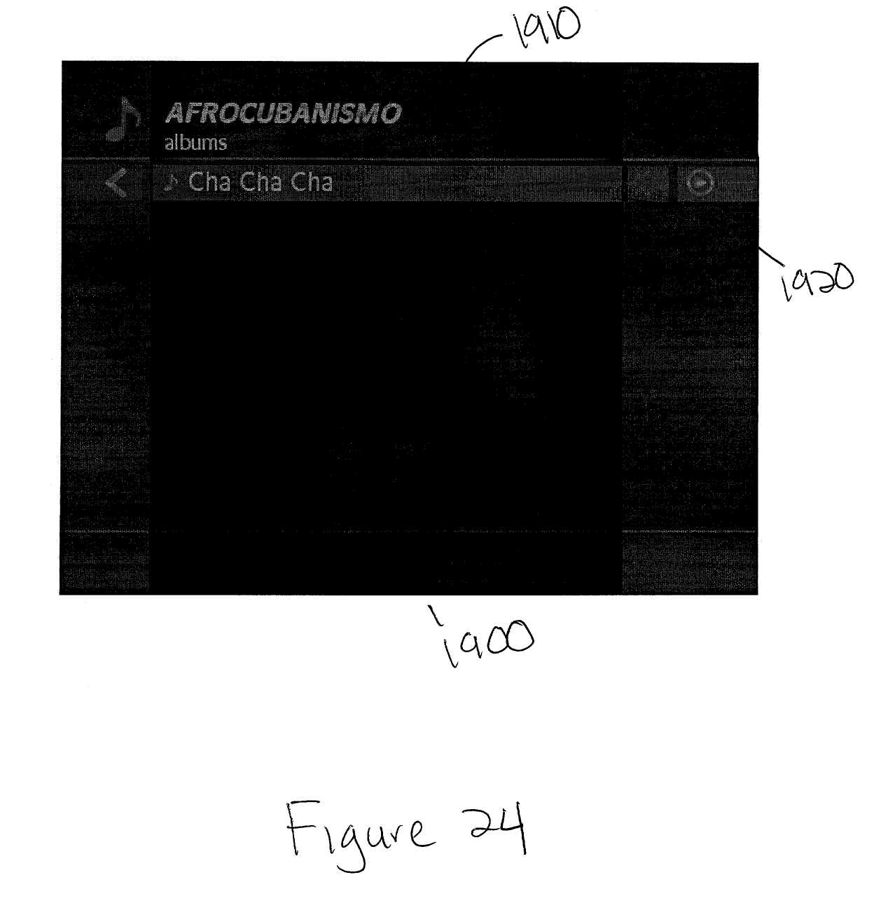

FIG. 24 illustrates an example screen displayed in response to the user's selection of an album. Specifically, as shown in FIG. 24, the system displays the tracks associated with the selected album, Afrocubanismo. The title portion of the screen (1910) displays the name of the album as well as the “albums” category. The highlighted track (1920) includes the display of the play symbol to indicate to the user that the user may play the selected track (e.g., Cha Cha Cha).

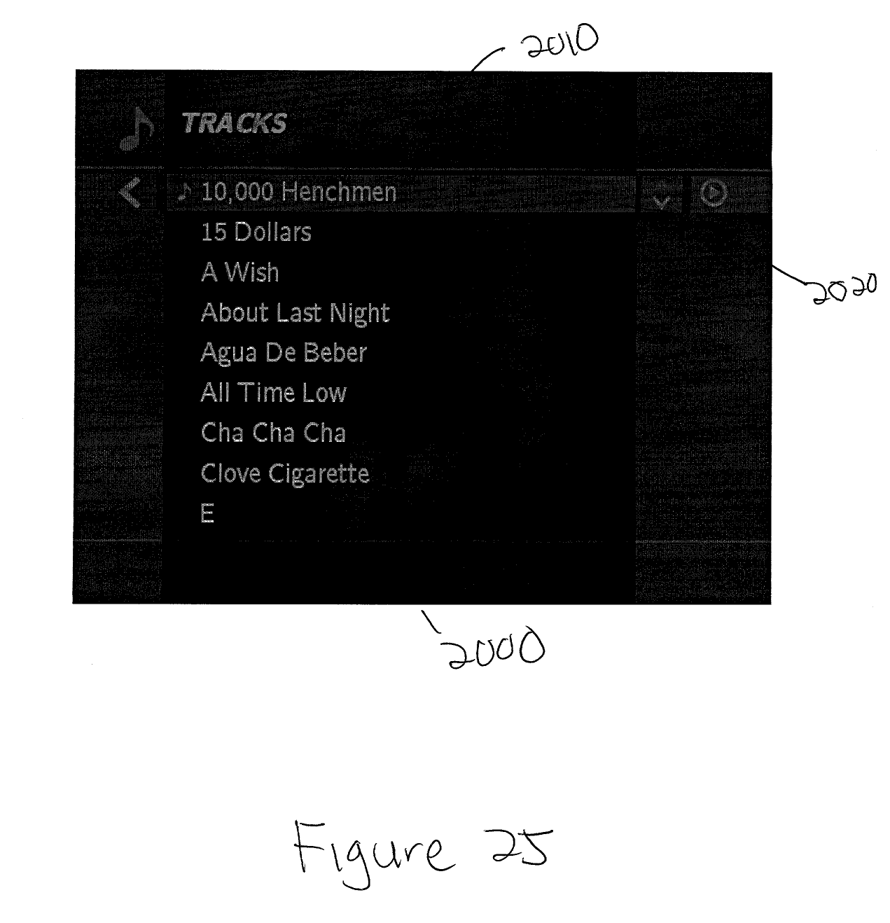

In one embodiment, the introduction screen 400 for the music jukebox application (FIG. 4) displays the item “All Tracks.” FIG. 25 illustrates an example screen that displays tracks for the music jukebox application. For this example, screen 2000 displays all tracks available in the media space. The title portion of the screen (2010) identifies the displayed items as tracks. The play symbol, displayed with a highlighted track (2020), permits the user to command the system to play the selected track.

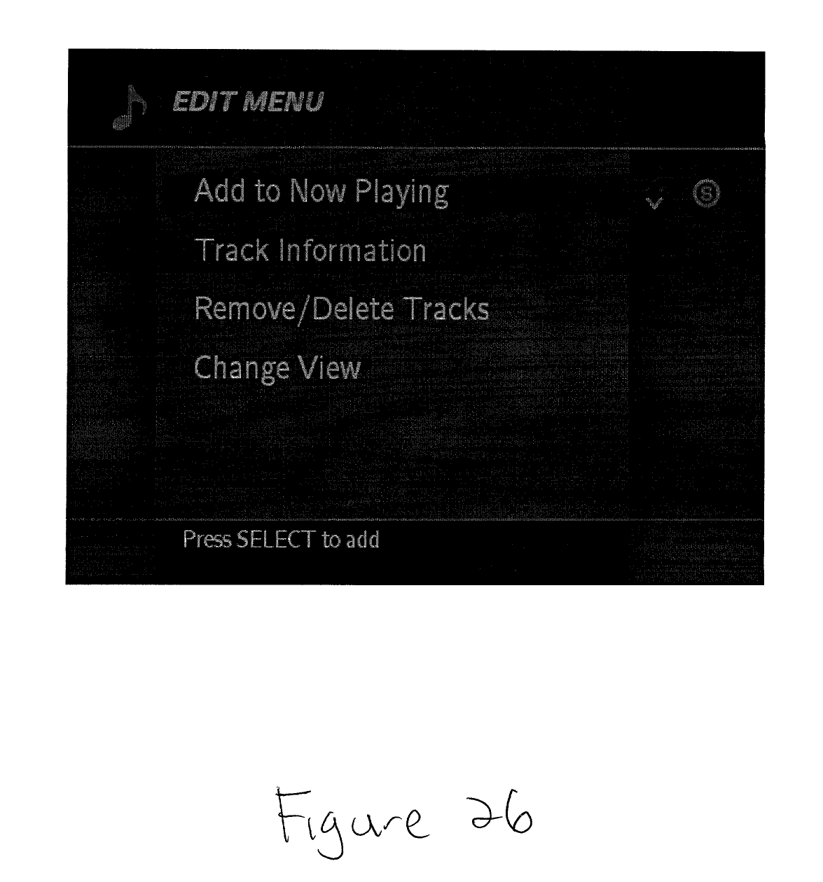

The user may invoke a second level user interface function (i.e., edit menu) from the “All Tracks” screen by selecting the menu button on the remote control. FIG. 26 illustrates an example screen displayed by the system if the user selects the menu button on the remote control within the context of an All Tracks screen. The edit menu in this context displays a plurality of menu items, including “Add to Now Playing”, “Track Information”, “Remove/Delete Tracks”, and “Change View.” To edit one of the menu items, the user highlights, with the remote control, a menu item, and selects the menu item. The edit sequence to the “Add to Now Playing” and “Track Information” functions involve the open text field, whereas the “Remove/Delete Tracks” and “Change View” utilize the scrollable widget sequence. These same edit menu options are available from any of the screens described above that present tracks to the user by pressing the edit button.

In one embodiment, the media convergence platform supports a compact disc (CD) audio application. In general, the CD audio screen permits the user to control one or more audio CDs within the media space. The user may select the CD audio application from the music jukebox screen (FIG. 4) (not shown). Also, the CD audio screen is displayed when the user plays an audio CD on a device in the media space. A CD audio screen displays information about the current CD playing or queued for play. For example, a CD audio screen may display items to identify tracks for one or more CDs playing on one or more devices. The user is permitted to scroll through the items to display additional tracks not originally displayed on the screen. In one embodiment, the CD audio screen displays metadata about the current album playing. The metadata may include the artist, tracks, album, genre, etc.

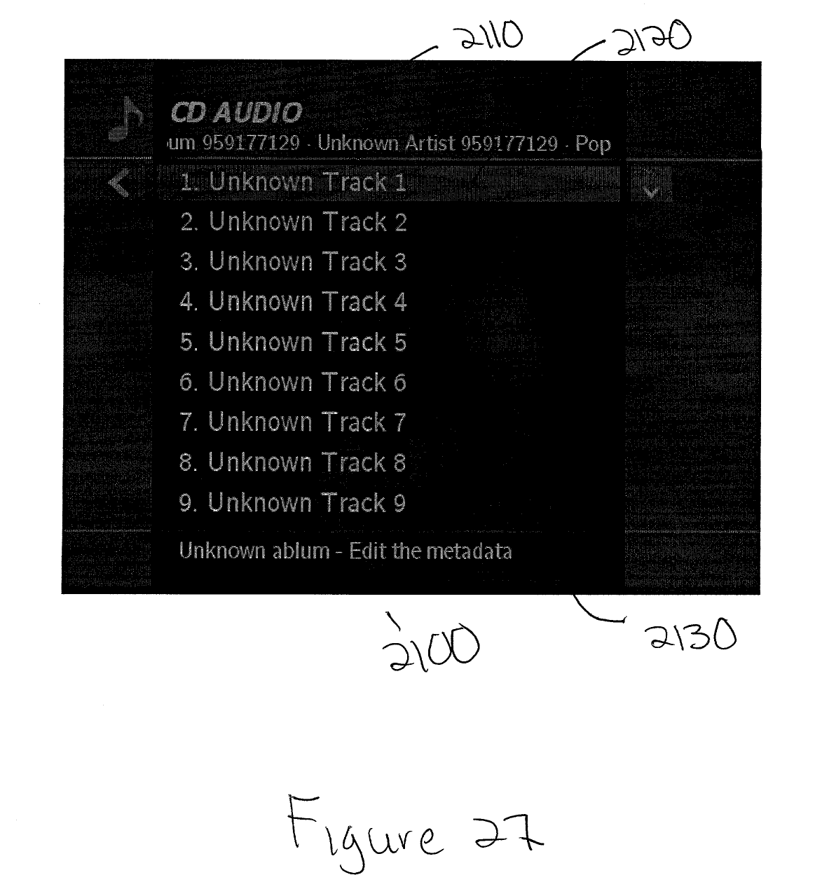

The music jukebox application supports copying or “ripping” audio CDs. FIG. 27 illustrates an example screen display for ripping an audio CD for the media convergence system. As shown in FIG. 27, screen 2100 displays, in the title portion 2110, the selected application, “CD Audio.” For this example, the CD is unrecognized by CDDB lookup of metadata. The screen 2100 also displays a plurality of tracks (e.g., tracks 1-9) for the current CD. At the bottom of screen 2100, labeled 2130 in FIG. 27, the user is prompted to edit the metadata as the current album is unknown. For this embodiment, the user edits the CD metadata by pressing the menu button and by entering information, such as the artist, track, album, genre, etc. After entering the metadata, the user directs the system to commence copying the CD (i.e., also by pressing the menu button). This operation occurs asynchronously to other system operations to allow the user to continue to use the system.

Photo Albums Application:

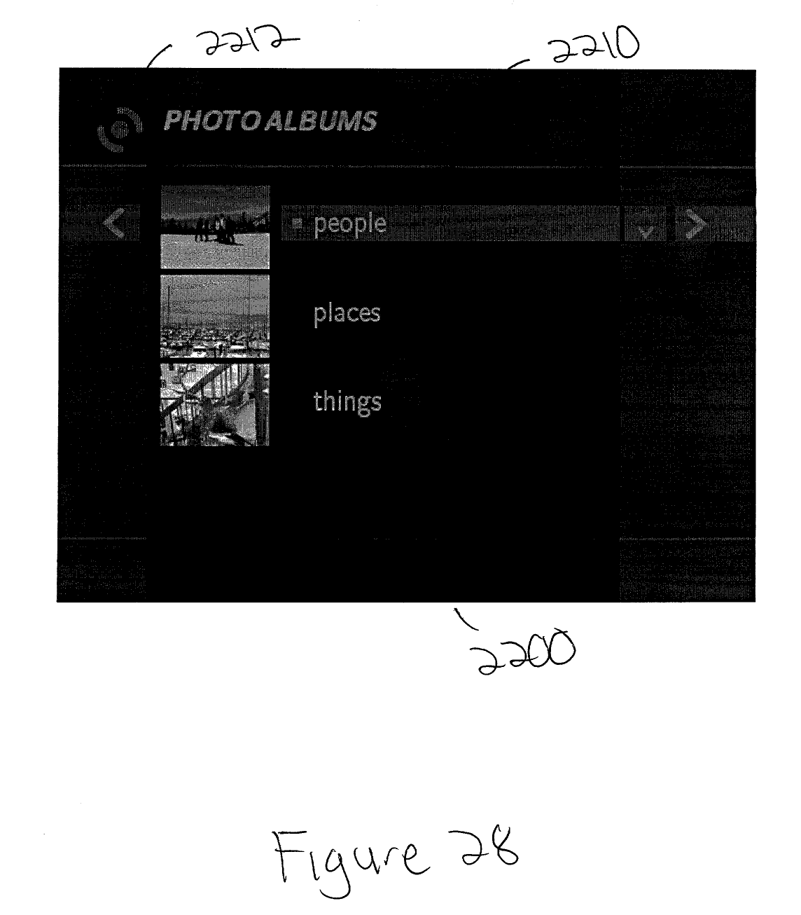

In one embodiment, one type of media supported by the system is digital photos. The example system introduction screen of FIG. 3 displays the “photo albums” item as an application for selection by the user. If the user selects the photo albums item from the system introduction screen, a photo album application introduction screen is displayed. FIG. 28 illustrates an example introduction screen for the photo albums application. The title portion 2210 of screen 2200 identifies the screen as part of the photo albums application. Also, the title portion 2210 displays an icon, 2212, to identify the photo album application. For this embodiment, screen 2200 displays photo albums available within the media space. For the example of FIG. 28, the available photo albums include “people”, “places”, and “things.” The highlighted item, “people”, includes arrows to inform the user that the user may: press the left arrow cursor control key to go back to the system introduction screen; press the up/down arrow keys to select items on the screen accordingly; or select the right arrow cursor control key to select the highlighted item (e.g., people).

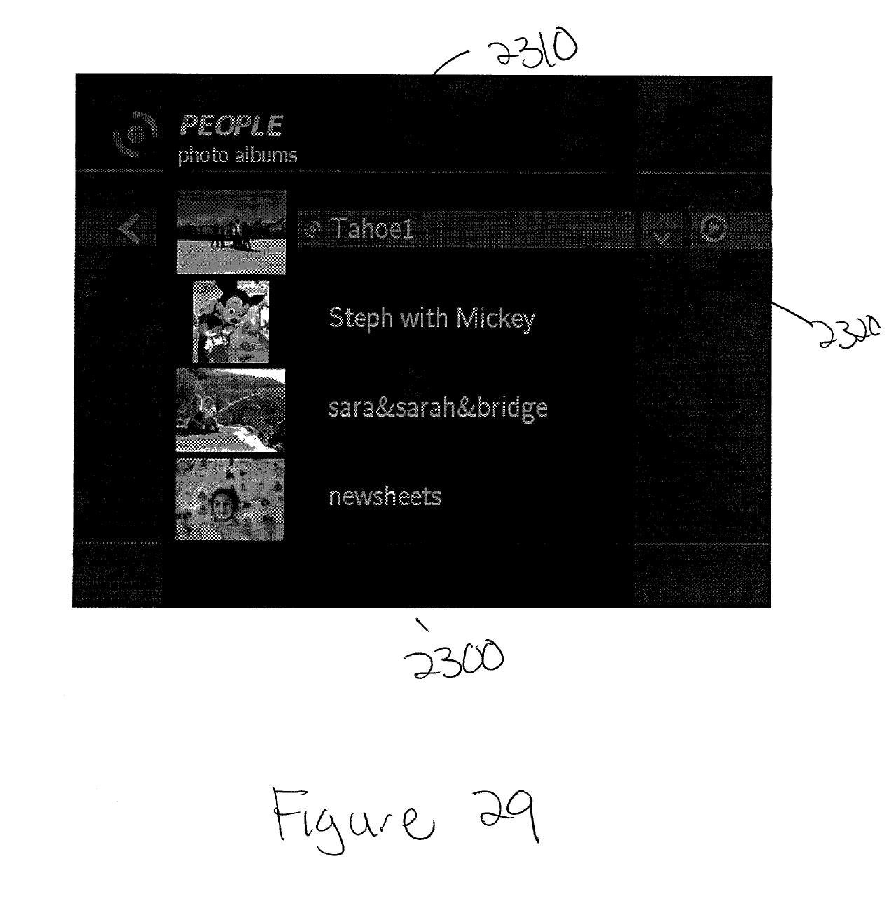

FIG. 29 illustrates an example screen displayed by the system in response to the user's selection of the photo album, people. As shown in FIG. 29, screen 2300 displays a plurality of items that identify photos in the selected photo album. Specifically, for this example, the people photo album includes the photos “Tahoe1”, “Steph with Mickey”, “sara&sarah&bridge”, and “newsheets.” The title portion of the screen 2310 displays the title the photo album selected (e.g., people) as well as an indication of the photo application and content (i.e., the photo icon as well as the word “photo albums” underneath the title of the photo album). The highlighted item 2320 displays arrows to indicate the user's option to go back to the photo application introduction screen (left arrow), scroll up and down to view or select additional items, or view the selected photo.

If the user selects the highlighted photo item, the system displays the photo in the screen. For example, the system may display the photo using the full screen of the display device (e.g., television). The user may also select a slide show of the photo album. In one embodiment, to display a slide show, the system displays, on a full screen, photos from the photo album for the duration of a predetermined time interval. After expiration of the time interval, the system displays, from the photo album, the next photo on the full screen. In this manner, the system sequences through the photo album. In one embodiment, the photo album application also includes a shuffle feature. For the shuffle feature, the display order of photos is mixed.

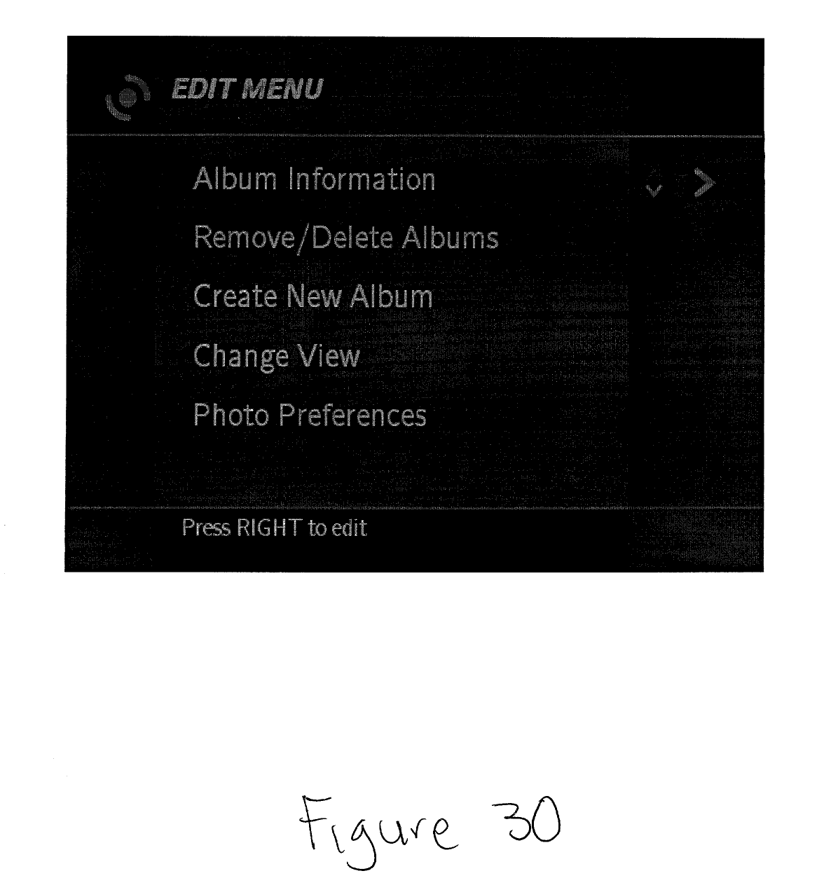

The user may invoke a second level user interface function (i.e., edit menu) from the photos album application by selecting the menu button on the remote control. FIG. 30 illustrates an example screen displayed by the system if the user selects the menu button on the remote control within the context of the photo albums application. The edit menu in this context displays a plurality of menu items, including “Album Information”, “Remove/Delete Albums”, “Create New Album”, “Change View”, and “Photo Preferences.” The user highlights, with the remote control, a menu item to select a menu item. The editing sequence for the “Album Information” function uses the open text field approach, and the editing sequence for the “Remove/Delete Albums”, “Create New Album”, “Change View”, and “Photo Preferences” uses the scrollable widget approach.

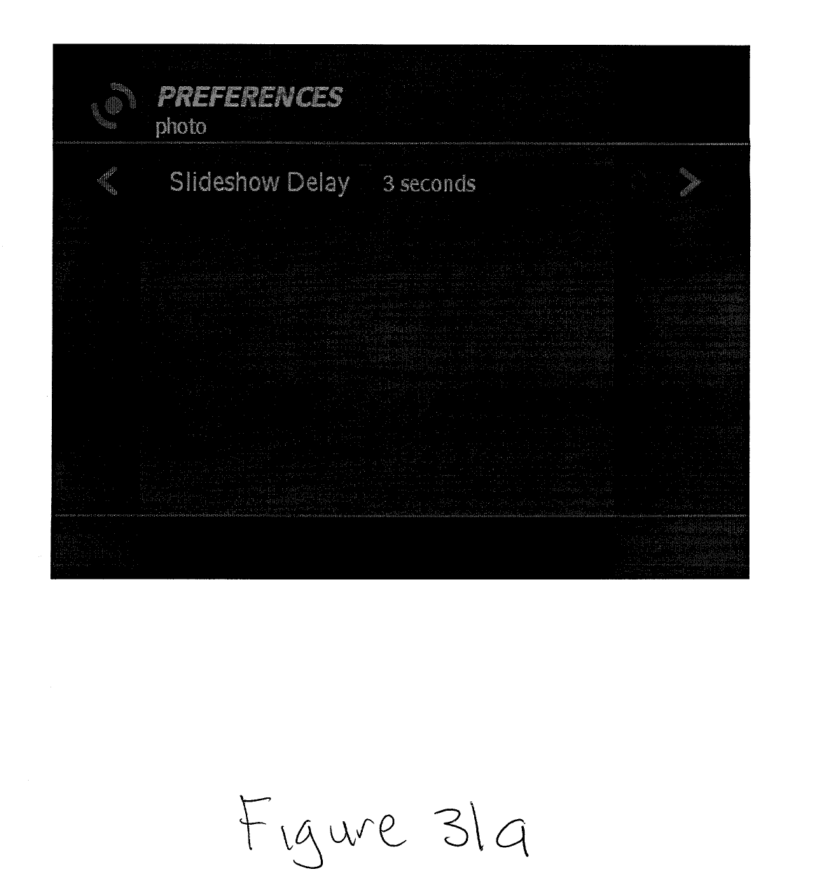

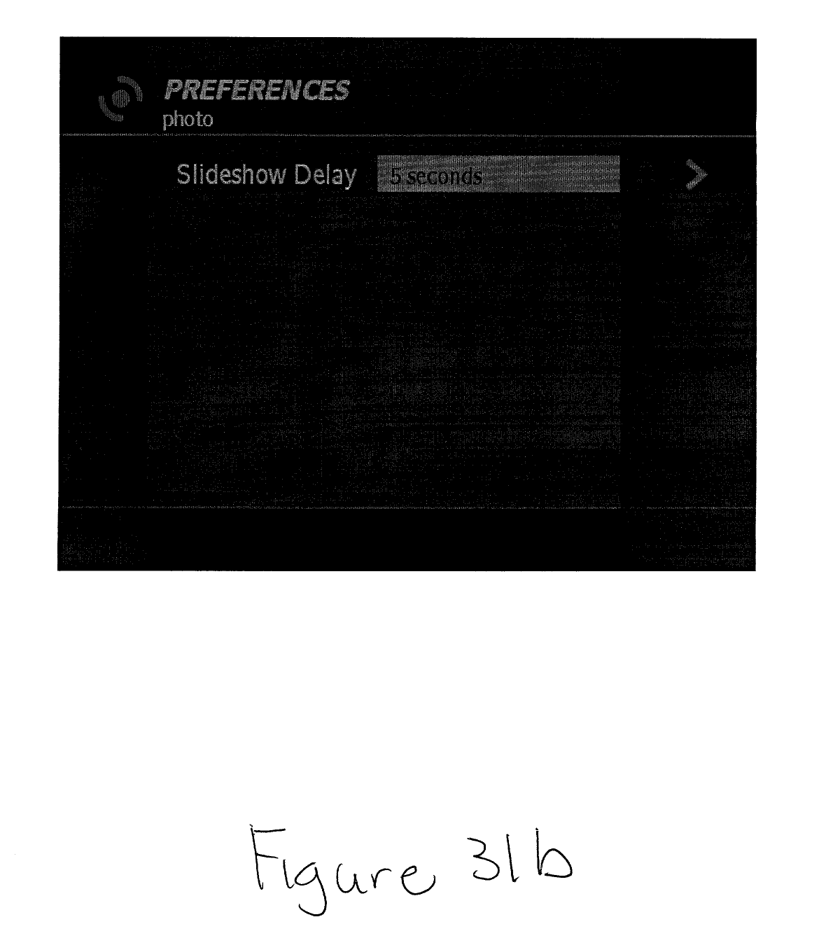

FIG. 31a illustrates an example screen displayed by the system in response to the user's selection of the Photo Preferences function in the edit menu of FIG. 30. The example screen for the Photo Preferences function displays parameters and the associated setting for the corresponding parameter. Specifically, the time delay for a slide show, “Slideshow Delay”, is displayed with the current setting, “3 seconds.” To edit the amount of time between the display of photos in a slide show, the user scrolls through the selectable widgets to select the desired time delay. FIG. 31b illustrates an example screen displayed by the system in response to the user selecting, using the selectable widgets approach, a time delay of “5 seconds.”

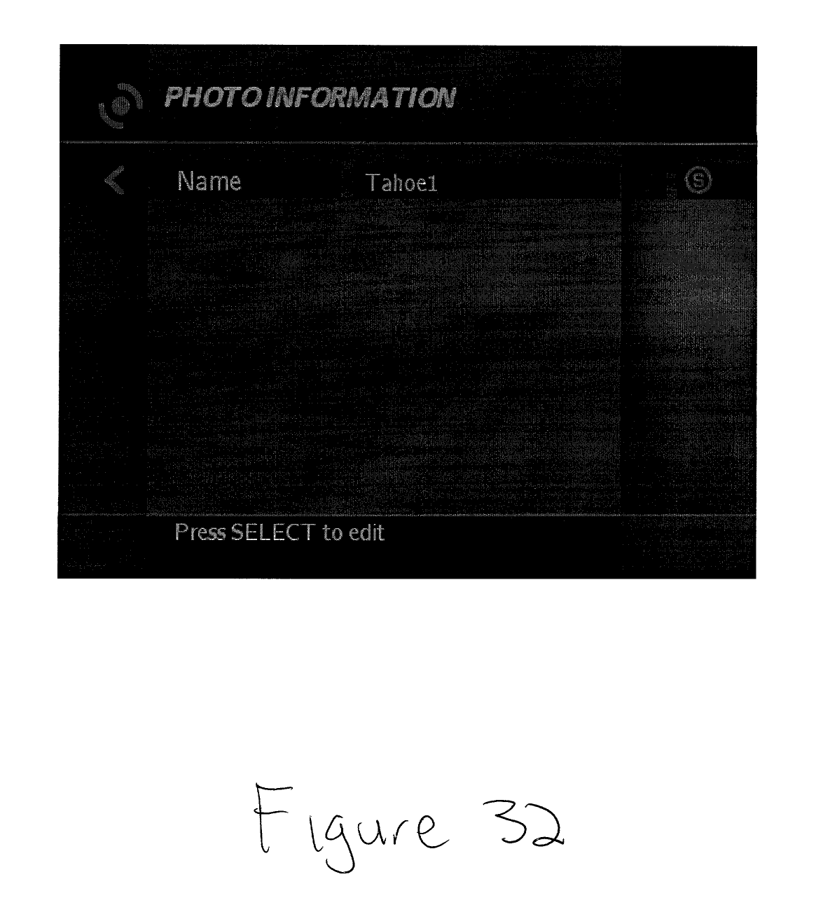

The edit menu for the photo albums application also includes the function “Photo Information (FIG. 30). FIG. 32 illustrates an example screen displayed by the system in response to the user's selection of the Photo Information function in the edit menu of the photo albums application when a photo album has been selected. One parameter in the Photo Information function permits the user to enter a name for the selected photo album. For the example of FIG. 32, the user, using the open text field approach, enters the name “Tahoe1” for the selected photo album.

Video Clips Application:

In one embodiment, the media convergence platform integrates, as a type of media, video clips. In general, the video clips application permits a user to manage video imported into the media space. The video clips may originate from any source, such as a user's personal video (e.g., generated from the user's video camera) or content imported into the media space, such as content downloaded from the Internet. The system introduction screen of FIG. 3 displays an item for the video clips application. For this embodiment, if the user selects the video clips application from the system introduction screen, an introduction screen to the video clips application is displayed.

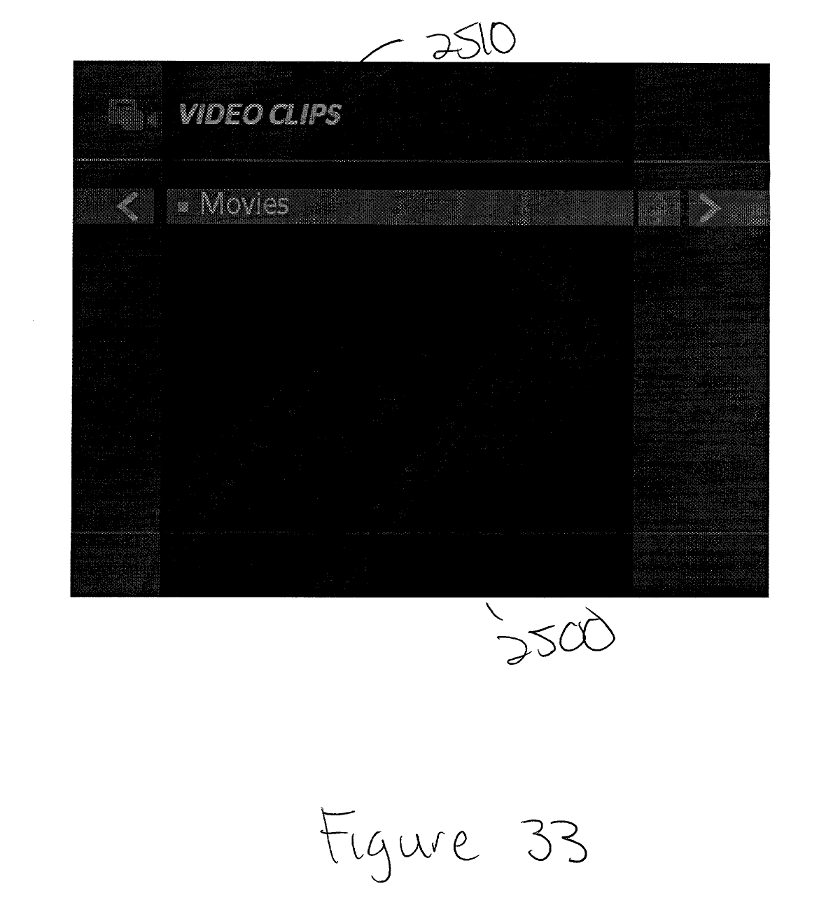

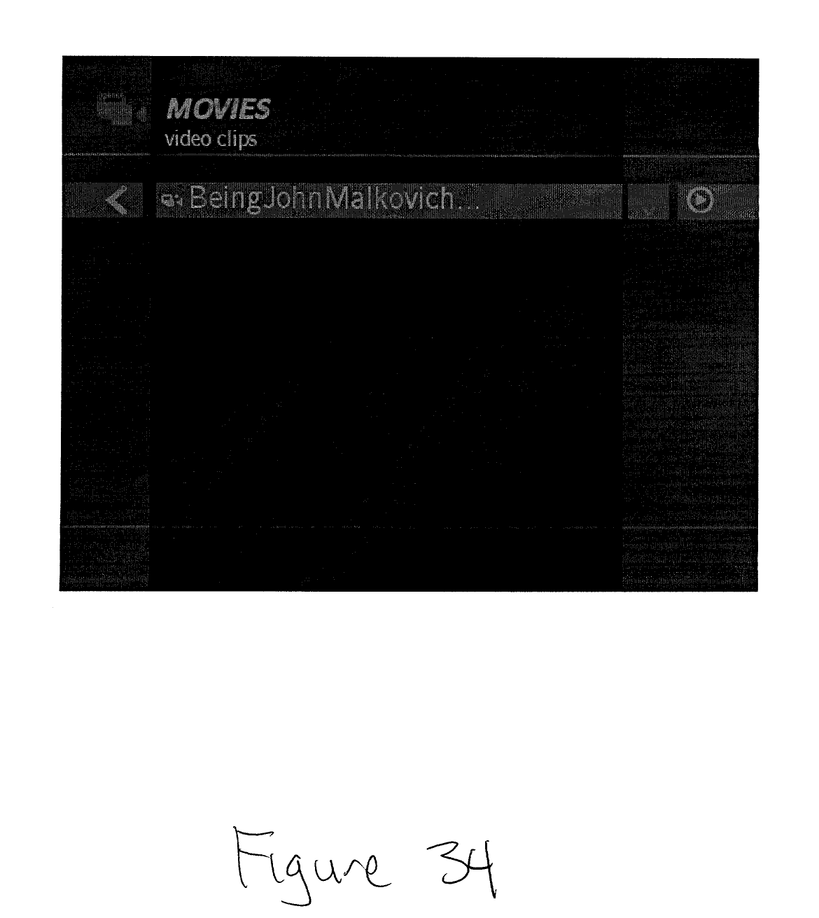

FIG. 33 illustrates an example screen for the video clips application. As shown in FIG. 33, screen 2500 displays items for the video clips application. The video clips may be organized into categories or folders. The example introduction video clips screen 2500 includes video clips arranged into the category “Movies.” Although the example screen 2500 shows a category for “Movies”, any categories may be generated to organize video clips. The top portion of the screen (2510) identifies the video clips application via the text and icon. If the user selects an item from the video clips introduction screen (2500), the system displays items to identify the corresponding video clip. FIG. 34 illustrates an example screen displayed by the system in response to the user selection of the item “Movies” from screen 2500 (FIG. 33). For this example, the system stores a video clip from the movie “BeingJohnMalkaovich . . . ”

In one embodiment, a PC download function permits a user to view video clips downloaded on the user's PC on any output display within the media space. For example, the user may desire to view video clips downloaded on the user's PC on a television screen within the media space. A television may provide a viewing device more suitable than the user's PC. Thus, the media convergence platform system delivers media at locations selected by the user (e.g., a television in the living room). The PC download video clips may include content that the user previously downloaded to the PC.

Internet Content:

The media convergence platform optionally integrates external content (e.g., Internet content) into the media space. The Internet content may comprise any type of content, such as digital audio, digital video, or images. The Internet content application filters rich content for display on a television. The system integrates Internet content to maximize viewing of Internet content on a television display. To this end, the system provides a broadcast focus of content, as opposed to a literal web focus to display content (i.e., displaying pages of HTML). In one embodiment, to integrate Internet content into the media space, the system defines a hierarchy of information with eXtensible markup language (XML) descriptors. The XML descriptions define the content the system displays on an output device. Through this XML description, content providers can provide both stream and cache based content to the users of the mediaspace formatted and presented in a manner that is intended for TV consumption but yet still specified by the content provider.

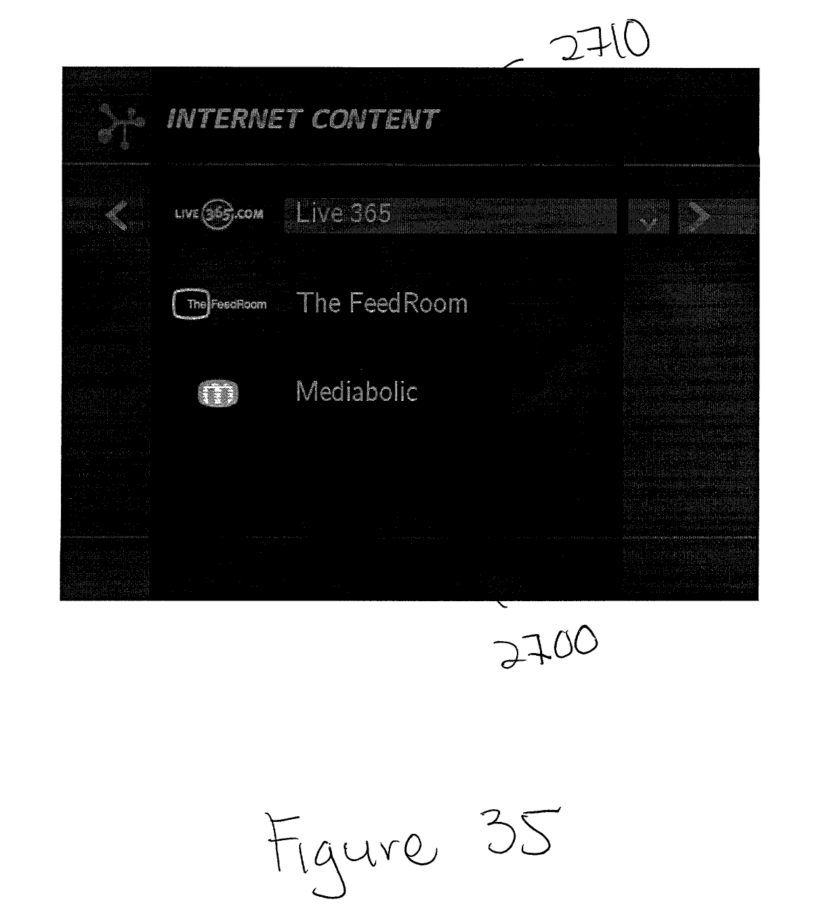

In one embodiment, the user may select the Internet content application from the system introduction screen (FIG. 3). In response to the user's selection of the Internet content application, the system displays an Internet content introduction screen. FIG. 35 illustrates an example introduction screen for the Internet content application. For this embodiment, the introduction screen 2700 displays items to identify available Internet content. Specifically, for this example, the available Internet content includes Live 365.com, the FeedRoom, and Mediabolic. The introduction screen includes a title portion (2710) to identify that the user has selected the Internet content application. Arrows are displayed for a highlighted item to provide the user guidance as to the selectable options.

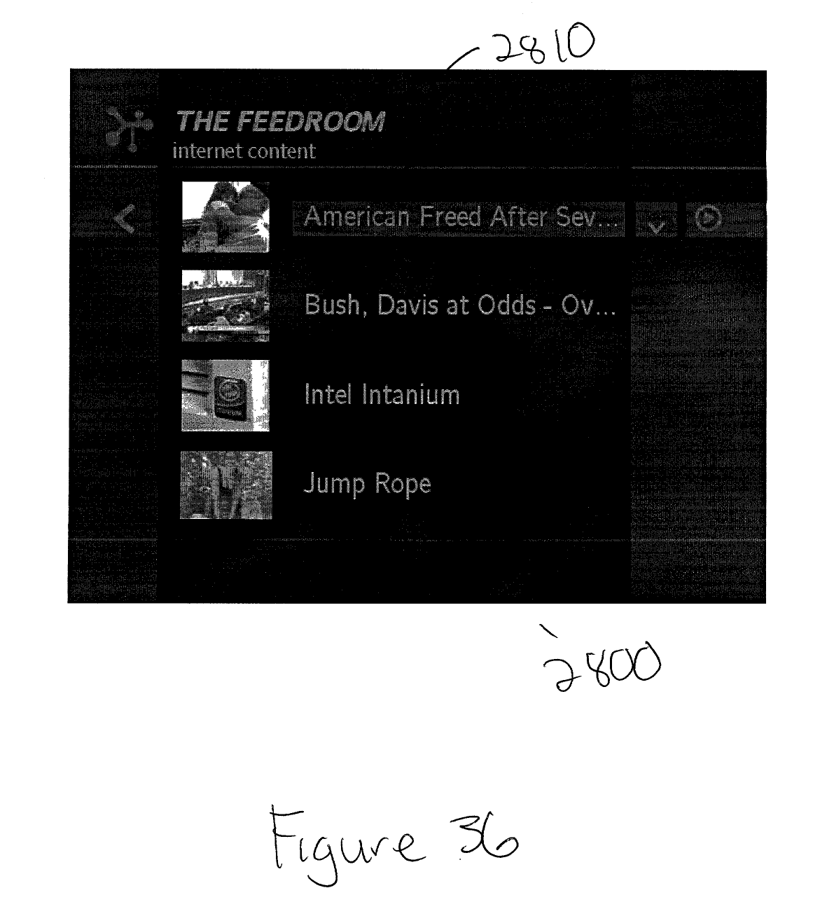

FIG. 36 illustrates an example screen for the display of content from the Internet content provider, “The Feed room.” In one embodiment, the Internet content provider defines, using XML descriptors, the introduction screen to access the content. For this example, several video clips are accessible from screen 2800. A title portion (2810) identifies the Internet content provider (e.g., The Feedroom) as well the Internet content application. The highlighted item displays, in addition to the appropriate arrows, a play symbol. If the user selects to play an item, the system displays a full screen display of the corresponding Internet content (e.g., news clip).

System Edit & Status:

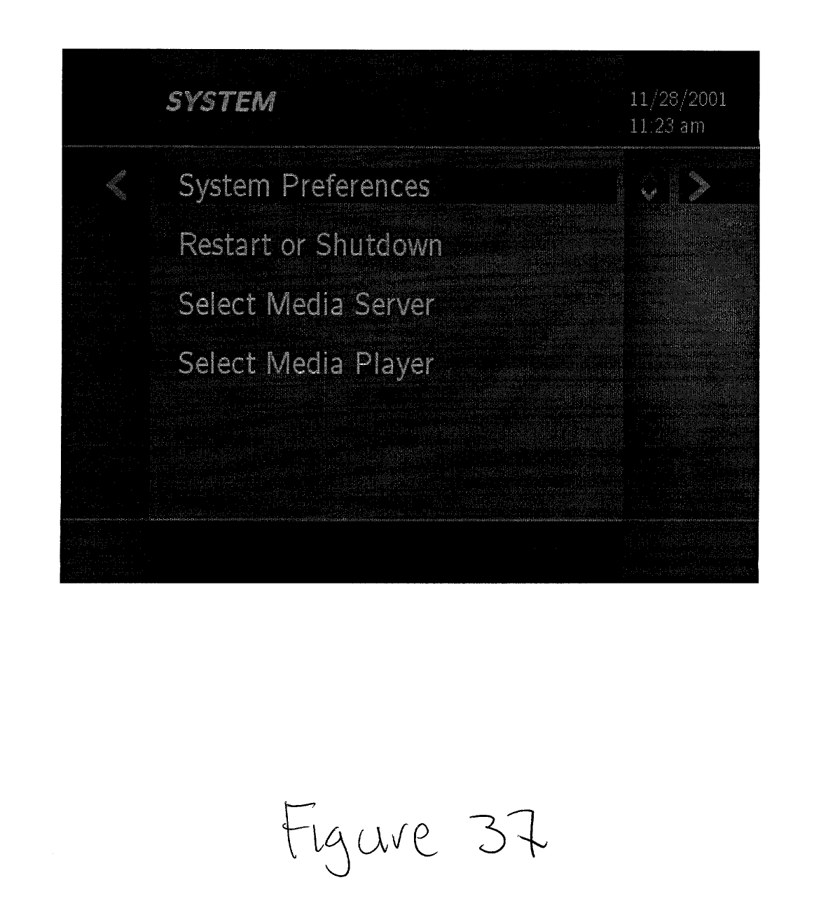

The user may invoke a second level user interface function from the top-level or introduction screen (FIG. 3) by selecting the menu button on the remote control. FIG. 37 illustrates an example screen displayed by the system if the user selects the menu button on the remote control within the context of the top-level or introduction screen. The system displays a plurality of menu items, including “System Preferences”, “Restart or Shutdown”, “Select Media Server”, and “Select Media Player.”

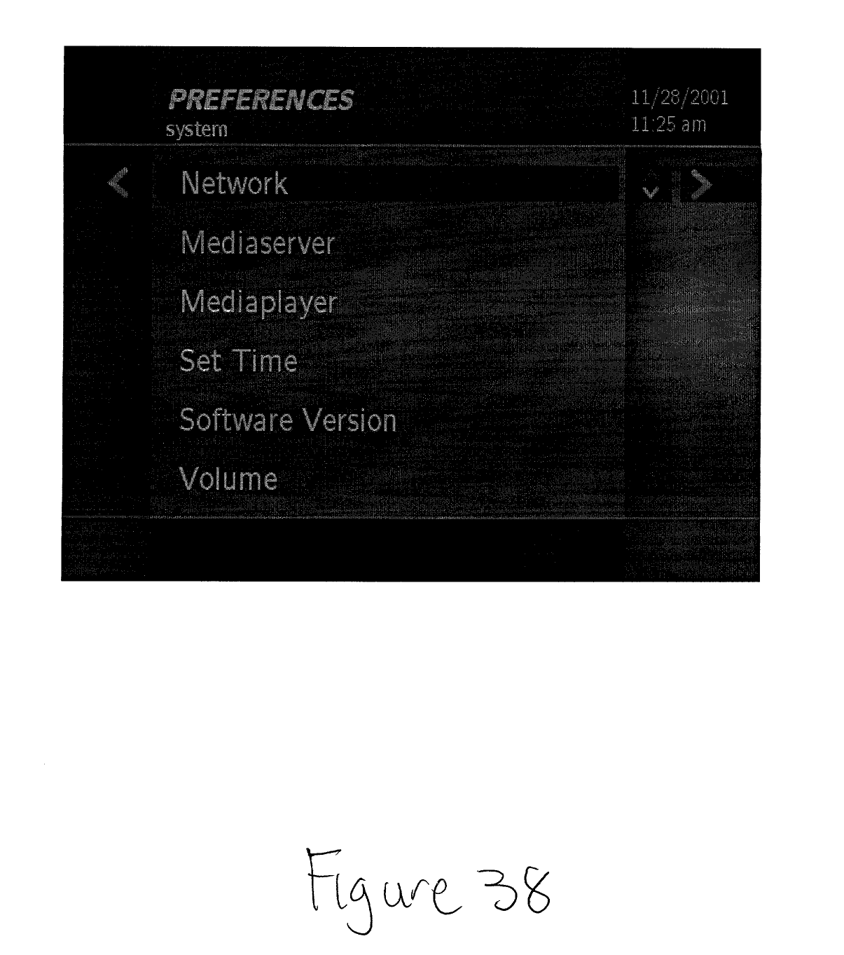

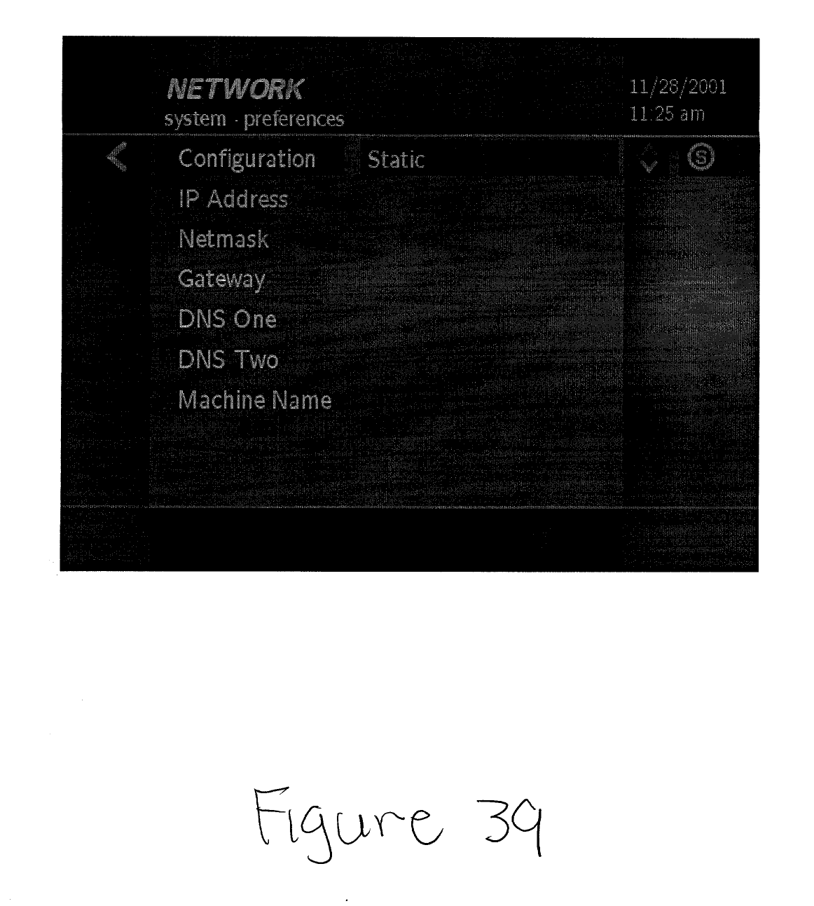

FIG. 38 illustrates one embodiment for a screen displayed by the system in response to a user selection of the “System Preferences” menu item of FIG. 37. The “System Preferences” function allows the user to obtain information and/or set parameters regarding “Network”, “Mediaserver”, “Mediaplayer”, “Set Time”, “Software Version”, and “Volume.” FIG. 39 illustrates an example screen displayed by the system to set parameters for Network preferences. As shown in FIG. 39, through this screen, the user may set the “Configuration”, “IP Address”, “Netmask”, “Gateway”, “DNS One”, “DNS Two”, and “Machine Name.”

In one embodiment, the media convergence system allows a user to obtain additional contextual information about a selected item or system-wide status information by pressing the status button on the remote. The status information may be displayed at the top of the screen. In general, the contextual status displays, for a selected item, the name of the item, information about when the item was created, and the name of the container for the item (i.e., the object that contains the item). The system-wide status displays information about any concurrent system-wide activity. In one embodiment, the status of an audio track identifies the name of the track, the total time duration of the track, the elapsed time of the track (i.e., the amount of time the track has been playing), the artist, album, and genre (if any) of the track. A user may also obtain status information about the downloading of Internet content as well as status information for ripping a CD. Furthermore, the user may obtain system status information regarding users logged into the system.

User Interface Implementation:

The user interface of the present invention is suitable for operation in conjunction with different types of output displays in the media space. Some media devices within the media space may have a television screen, while other media devices may include only a small liquid crystal display (LCD). The small LCDs only display a portion of the content that may be displayed on a larger television display. The underlying implementation of the user interface permits displaying content suitable for different types and sizes of output displays. Specifically, the user interface distinguishes between the application layer and the rendering layer. This distinction permits applying the same application logic for different display formats (e.g., television screens, LCDs, etc.). The basic components of the user interface include lists of items for display, and cursor keys for user input. For example, in the music jukebox application, the user interface may display a list of tracks on a television display as well as a list of tracks on a small LCD display (e.g., the thin audio client).

1. A method of implementing a user interface for a media server for storing media objects comprising music, photos, and videos in a networked media convergence platform through a television display, said networked media convergence platform further comprising a plurality of local networked media devices, said method comprising the steps of:
displaying, on said television display, a selectable item to represent a music application, said music application permits a user to select, add, and delete music available within said networked media convergence platform system, and to playback said music through a dedicated networked audio media device in said networked media convergence platform, said dedicated networked audio media device being configured to only playback audio media objects and not being configured to playback video or photo media objects;
displaying, on said television display, a selectable item to represent a photo albums application, said photo albums application permits a user to select, add, and delete one or more photos available within said networked media convergence platform, and to view said photos through a networked media device in said networked media convergence platform;
displaying, on said television display, a selectable item to represent a video application, said video application permits a user to select, add, and delete one or more videos available within said networked media convergence platform and to playback said video through a networked media device in said networked media convergence platform; and
receiving input for said media server in said networked media convergence platform from a user to select said music application, said photo albums application, and said video application.

2. The method as set forth in claim 1, further comprising the step of displaying, on said television display, a selectable item to represent an Internet content application, said Internet content application permits a user to select an Internet content provider, available to said networked media convergence platform, and to receive content from said Internet content provider through a networked media device of said networked media convergence platform.

3. The method as set forth in claim 1, further comprising the step of displaying, on said television display, a plurality of items for selection by a user to edit said music application, said photo albums application, or said video application in response to a predetermined user input.

4. The method as set forth in claim 1, further comprising the step of displaying, on said television display, status of one or more parameters of said networked media convergence platform.

5. The method as set forth in claim 1, wherein said music application further permits a user to view, on said television display, one or more objects playing or queued to be played on a networked media device in said networked media convergence platform.

6. The method as set forth in claim 5, wherein said music application further permits a user to generate and playback one or more playlists.

7. The method as set forth in claim 6, wherein said playlists comprise one or more musical objects.

8. The method as set forth in claim 7, wherein said musical objects comprise tracks, albums, playlists, artists, and genres.

9. The method as set forth in claim 1, wherein said music application further permits a user to arrange, view and select, for playback, musical objects by genres.

10. The method as set forth in claim 1, wherein said music application further permits a user to arrange, view and select, for playback, musical objects by artist.

11. The method as set forth in claim 1, wherein said music application further permits a user to arrange, view and select, for playback, musical objects by albums.

12. The method as set forth in claim 1, wherein said music application further permits a user to arrange, view and select, for playback, musical objects by tracks.

13. The method as set forth in claim 1, wherein said music application further permits a user to copy a compact disc from audio of a musical object within said convergence platform system.

14. The method as set forth in claim 1, wherein said photo albums application further permits a user to arrange, view and select, for playback, photos arranged in photo albums.

15. The method as set forth in claim 14, wherein said photo albums application further permits a user to execute a slide show on a selected photo album.

16. A networked media convergence platform system comprising:
a media server, said media server for storing media objects comprising music, photos, and videos;
a plurality of local networked media devices for playback of media objects available within said networked media convergence platform system;
a television display, for implementing a user interface for said networked media convergence platform system, said user interface for:
displaying, on said television display, a selectable item to represent a music application, said music application permits a user to select, add, and delete music available within said networked media convergence platform system, and to playback said music through a dedicated networked audio media device in said networked media convergence platform system said dedicated networked audio media device being configured to only playback audio media objects and not being configured to playback video or photo media objects;
displaying, on a television display, a selectable item to represent a photo albums application, said photo albums application permits a user to select, add, and delete one or more photos available within said networked media convergence platform system, and to view said photos through a networked media device in said networked media convergence platform system;
displaying, on a television display, a selectable item to represent a video application, said video application permits a user to select, add, and delete one or more videos available within said networked media convergence platform system and to playback said video through a networked media device in said media networked convergence platform system; and
an input device for a media server in said networked media convergence platform system, said input device receiving input from a user to select said music application, said photo albums application, and said video application.

17. The networked media convergence platform system as set forth in claim 16, wherein said user interface further comprising an element for displaying, on said television display, a selectable item to represent an Internet content application, said Internet content application permits a user to select an Internet content provider, available to said networked media convergence platform system, and to receive content from said Internet content provider through a networked media device of said networked media convergence platform system.

18. The networked media convergence platform system as set forth in claim 16, wherein said user interface further comprising an element for displaying, on said television display, a plurality of items for selection by a user to edit said music application, said photo albums application, or said video application in response to a predetermined user input.

19. The networked media convergence platform system as set forth in claim 16, wherein said user interface further comprising an element for displaying status of one or more parameters of said networked media convergence platform system.

20. The networked media convergence platform system as set forth in claim 16, wherein said music application further permits a user to view, on said television display, one or more objects playing or queued to be played on a networked media device in said networked media convergence platform system.

21. The networked media convergence platform system as set forth in claim 20, wherein said music application further permits a user to generate and playback one or more playlists.

22. The networked media convergence platform system as set forth in claim 21, wherein said playlists comprise one or more musical objects.

23. The networked media convergence platform system as set forth in claim 22, wherein said musical objects comprise tracks, albums, playlists, artists, and genres.

24. The networked media convergence platform system as set forth in claim 16, wherein said music application further permits a user to arrange, view and select, for playback, musical objects by genres.

25. The networked media convergence platform system as set forth in claim 16, wherein said music application further permits a user to arrange, view and select, for playback, musical objects by artist.

26. The networked media convergence platform system as set forth in claim 16, wherein said music application further permits a user to arrange, view and select, for playback, musical objects by albums.

27. The networked media convergence platform system as set forth in claim 16, wherein said music application further permits a user to arrange, view and select, for playback, musical objects by tracks.

28. The networked media convergence platform system as set forth in claim 16, wherein said music application further permits a user to copy a compact disc from audio of a musical object within said networked media convergence platform system.

29. The networked media convergence platform system as set forth in claim 16, wherein said photo albums application further permits a user to arrange, view and select, for playback, photos arranged in photo albums.

30. The networked media convergence platform system as set forth in claim 29, wherein said photo albums application further permits a user to execute a slide show on a selected photo album.

31. The networked media convergence platform system as set forth in claim 16, wherein said dedicated networked audio media device comprises a stereo system.

32. The method as set forth in claim 1, wherein said dedicated networked audio media device comprises a stereo system.
